(19) United States
(12) Patent Application Publication
(10) Pub. No.: US 2018/0247016 A1
(43) Pub. Date: Aug. 30, 2018

(54) SYSTEMS AND METHODS FOR PROVIDING ASSISTED LOCAL ALIGNMENT

(71) Applicant: Seven Bridges Genomics Inc., Cambridge, MA (US)

(72) Inventor: Vladimir Semenyuk, Monterey, CA (US)

(73) Assignee: Seven Bridges Genomics Inc., Cambridge, MA (US)

(21) Appl. No.: 15/887,216

(22) Filed: Feb. 2, 2018

Related U.S. Application Data
(60) Provisional application No. 62/453,806, filed on Feb. 2, 2017.

(51) Int. Cl. G06F 19/22; G06F 19/16

(52) U.S. Cl. CPC G06F 19/22; G06F 19/16

(57) ABSTRACT

A method of aligning a data sequence to one or more reference sequences represented as a sequence variation graph (SVG) is disclosed. The method can comprise receiving one or more alignment candidate regions and corresponding ordered seeding information. For each of the received alignment candidate regions, a current seed is determined, the current seed being a next-in-order unprocessed seed based on the ordered seeding information. Data paths in the alignment candidate region are then traversed to identify potential next seeds relative to the current seed. If at least one potential next seed is found, a next seed is selected and alignment results are generated by applying a local alignment procedure to align query data in portions of the query data sequence between the current seed and the next seed with reference data in portions of the alignment candidate region located between the current seed and the next seed.

### CROSS-REFERENCE TO RELATED APPLICATIONS

This application claims priority from U.S. Provisional Patent Application Ser. No. 62/453,806, filed on Feb. 2, 2017 and entitled “SYSTEMS AND METHODS FOR PROVIDING ASSISTED LOCAL ALIGNMENT”, the disclosure of which is hereby incorporated by reference.

### FIELD

The present application generally relates to systems and methods for locally aligning reads against reference data, and more particularly to systems and methods for providing assisted local alignment.

### BACKGROUND

A person's genetic information has the potential to reveal much about their health and life. A risk of cancer or a genetic disease may be revealed by the sequences of the person's genes, as well the possibility that his or her children could inherit a genetic disorder. Genetic information can also be used to identify an unknown organism, such as potentially infectious agents discovered in samples from public food or water supplies. Next-generation sequencing (NGS) technologies are available that can sequence entire genomes quickly. Sequencing by NGS produces a very large number of short sequence reads. Each sequence read represents a short sequence of part of the genome of an organism. Unfortunately, analyzing short sequences is not an easy task.

Some approaches to analyzing sequence reads involve aligning the sequence reads to reference genome data. Aligning sequence reads to reference genome data generates information about the relationship or relatedness of the sequence read and portions of the reference data. Reference genome data may include long reference genome sequences and/or aggregates of reference genome sequences. The size of and nature of reference genome data therefore results in significant obstacles when attempting to successfully align sequence reads.

For example, the 1,000 Genomes Project has sequenced the genomes of 2,504 humans. A typical genome reference contains billions of data symbols (e.g., nucleotides). Still, even if the sequence reads are from a known species, there may be a great amount of known genetic variation in that species, i.e., a great diversity of different genotypes among members of the species, that add to the complexity of the reference genome data against which sequence reads are to be aligned. It therefore quickly becomes computationally intractable to perform an exhaustive alignment for even a single sequence read against the entire length of each and every one of the known human genomes. In fact, it is not even a trivial problem to simply store and represent all of the complete sequences of all of the known genomes for some organisms.

Traditional methods for aligning sequence reads to complex and large amounts of reference data often apply a two-step approach involving a “course” and “fine” stages, such as a global search algorithm, in combination with a local sequence aligner. The global search algorithm finds limited local regions within the entire reference data that are relevant and/or suitable for alignment, thereby reducing the overall search space for aligning entire sequence reads. The identified regions suitable for alignment are then locally aligned using traditional alignment algorithms such the Smith-Waterman algorithm, the Needleman-Wunsch algorithm, or variations thereof. Nonetheless, these alignment techniques continue to be quite complex even when aided by the application of global search algorithms to find limited local regions within the reference data for alignment. For instance, the complexity of applying the Smith-Waterman algorithm and similar alignment techniques is O (m*n), where m and n are sizes of the read and the reference data being aligned, respectively. Applying a global search algorithm may significantly reduce the amount of reference data that must be compared using the Smith-Waterman algorithm, such that the complexity is

$$O ( m * \frac{n}{z} ) ,$$

where

$$\frac{1}{z}$$

reflects the percentage decrease in the amount of reference data that must be compared to the sequence read. However, in many cases the reduction in search space may not be significant, or is otherwise offset by the computational cost of the global search algorithm.

Accordingly, there is a need to provide assisted local alignment that further reduces the complexity and increases the speed and accuracy of alignment (and global search and local alignment) techniques by, among other things, reducing the amount of data to be aligned. There is a need for such assisted local alignment to be applicable to the alignment of reads to large reference data sets, including reference genome sequence data, represented in graphs. Moreover, there is a need to effectively leverage information about identified local regions in the reference data, and information associated with data subsequences of the reference data, to reduce the complexity of local alignment.

### SUMMARY

Systems and methods are generally provided for assisted local alignment. In some example embodiments, assisted local alignment is used to align a read to reference data by aligning areas between or adjacent to matching blocks, or k-mers, in a read to areas between or adjacent to the matching blocks in a graph. Matching blocks refer to data subparts of the sequence read that are also found in the reference data. More specifically, in some example embodiments, assisted local alignment includes generating or retrieving a reference graph against which a read is to be aligned. The reference graph (e.g., a directed acyclic graph (DAG), sequence variation graph (SVG), or the like) represents reference data such as reference genome sequence data. The reference data represented in the reference graph is indexed to create a search index used to provide efficient searching thereof. Read data (e.g., query data) is obtained for alignment against the reference graph. The read data may be a sequence read to be aligned against reference sequence data. The read data is segmented into blocks of data, which are searched for in the reference graph using the reference graph's search index. Blocks of data in the read data that are also found in the reference data (i.e., matching blocks) are further analyzed to identify candidate regions for alignment in the reference graph. The candidate regions refer to sections or portions of the reference graph that are considered to have a higher likelihood of a relationship or relatedness to the read data. The matching blocks in each of the candidate regions are used to identify data to align using a local aligner. Assisted local alignment aligns data between and/or adjacent to matching blocks. That is, assisted local alignment does not align the data of the matching blocks. Alignment segment results are generated by concatenating matching blocks in the graph with the aligned data between and/or adjacent to those matching blocks. Assisted local alignment reduces the amount of data being aligned by aligning only data found between matching blocks, and not aligning matching blocks themselves, which are considered to be already aligned. Because the areas between seeds are, in many cases, much smaller than the size of the read, alignment using assisted local alignment reduces computational complexity when compared to unassisted alignment (e.g., alignment of whole reads, or alignment of matching blocks).

### BRIEF DESCRIPTION OF THE DRAWINGS

The present application will be more fully understood from the following detailed description taken in conjunction with the accompanying drawings, in which:

FIG. 1 illustrates an SVG and related sequences, according to an exemplary embodiment;

FIG. 2 illustrates an exemplary embodiment of a format for computationally storing the SVG of FIG. 1;

FIG. 3 illustrates another exemplary embodiment of an SVG having multiple paths, and related sequences;

FIG. 4 illustrates a first path in the SVG of FIG. 3, with its corresponding data string and plurality of blocks;

FIG. 5 illustrates a second path in the SVG of FIG. 3, with its corresponding data string and plurality of blocks;

FIG. 6 illustrates a third path in the SVG of FIG. 3, with its corresponding data string and plurality of blocks; FIG. 7 illustrates a fourth path in the SVG of FIG. 3, with its corresponding data string and plurality of blocks;

FIG. 8 is a flowchart illustrating a method of mapping a subject sequence to an SVG, according to an exemplary embodiment;

FIG. 9 illustrates the location of a pattern string in the SVG of FIG. 3;

FIG. 10A illustrates an SVG for which to build a search index, according to an exemplary embodiment;

FIG. 10B illustrates a first path through the SVG of FIG. 10A;

FIG. 10C illustrates a second path through the SVG of FIG. 10A;

FIG. 10D illustrates the identification of two blocks in the SVG of FIG. 10A;

FIG. 11 illustrates an exemplary embodiment of floating-point projections to identify block location identifiers in the SVG of FIG. 10A;

FIG. 12 illustrates a single-read analysis of search result, according to an exemplary embodiment;

FIG. 13 illustrates a sliding window analysis of search results, according to an exemplary embodiment;

FIG. 14 illustrates a method for global searching, according to an exemplary embodiment;

FIG. 15 is a flowchart illustrating a method for assisted local alignment, according to an exemplary embodiment;

FIG. 16A illustrates a candidate region of an SVG during a method of assisted local alignment, according to an exemplary embodiment;

FIG. 16B illustrates a candidate region of an SVG during a method of assisted local alignment, according to an exemplary embodiment;

FIG. 16C illustrates a candidate region of an SVG during a method of assisted local alignment, according to an exemplary embodiment;

FIG. 16D illustrates a candidate region of an SVG during a method of assisted local alignment, according to an exemplary embodiment;

FIG. 16E illustrates a candidate region of an SVG during a method of assisted local alignment, according to an exemplary embodiment;

FIG. 16F illustrates a candidate region of an SVG during a method of assisted local alignment, according to an exemplary embodiment;

FIG. 16G illustrates a candidate region of an SVG during a method of assisted local alignment, according to an exemplary embodiment;

FIG. 16H illustrates a candidate region of an SVG during a method of assisted local alignment, according to an exemplary embodiment;

FIG. 16I illustrates a candidate region of an SVG during a method of assisted local alignment, according to an exemplary embodiment;

FIG. 16J illustrates a candidate region of an SVG during a method of assisted local alignment, according to an exemplary embodiment;

FIG. 16K illustrates a candidate region of an SVG during a method of assisted local alignment, according to an exemplary embodiment;

FIG. 16L illustrates a candidate region of an SVG during a method of assisted local alignment, according to an exemplary embodiment;

FIG. 16M illustrates a candidate region of an SVG during a method of assisted local alignment, according to an exemplary embodiment;

FIG. 16N illustrates a candidate region of an SVG during a method of assisted local alignment, according to an exemplary embodiment;

FIG. 16O illustrates a candidate region of an SVG during a method of assisted local alignment, according to an exemplary embodiment;

FIG. 17 illustrates mapping of a sequence read to a reference graph, according to an exemplary embodiment;

FIG. 18 illustrates matrices representing a comparison of sequences, according to an exemplary embodiment;

FIG. 19 is a flowchart illustrating a method of global searching, according to an exemplary embodiment; and

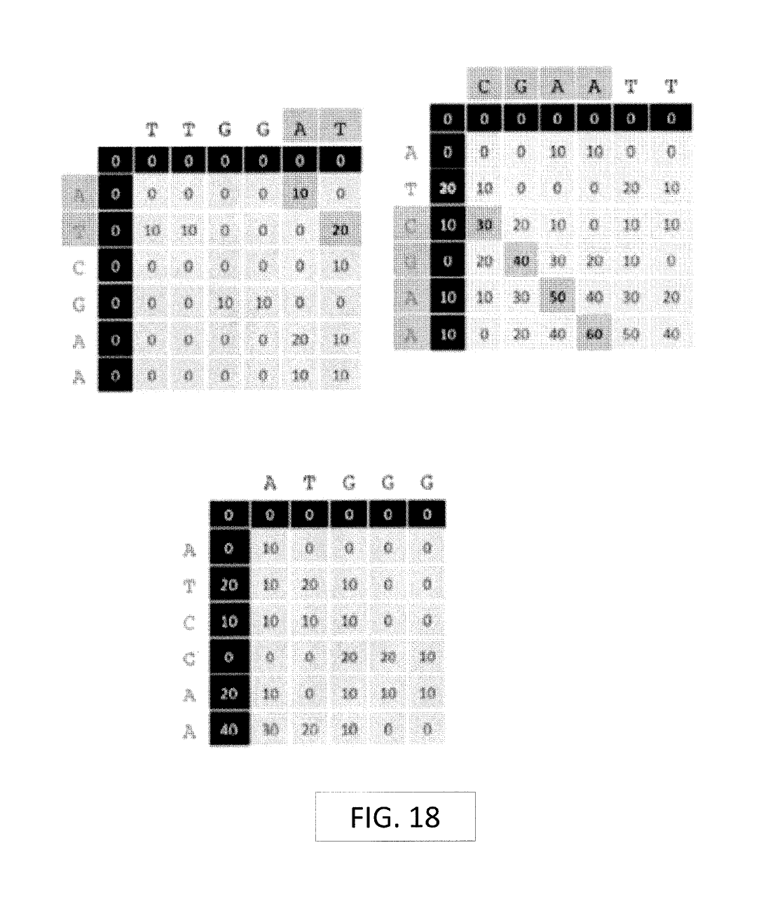

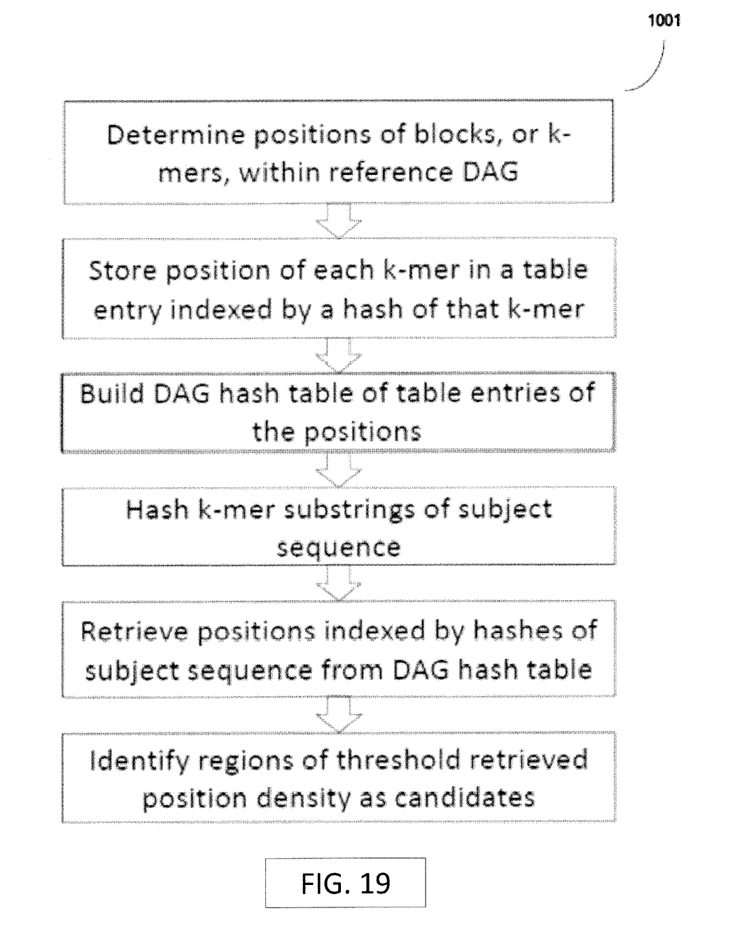

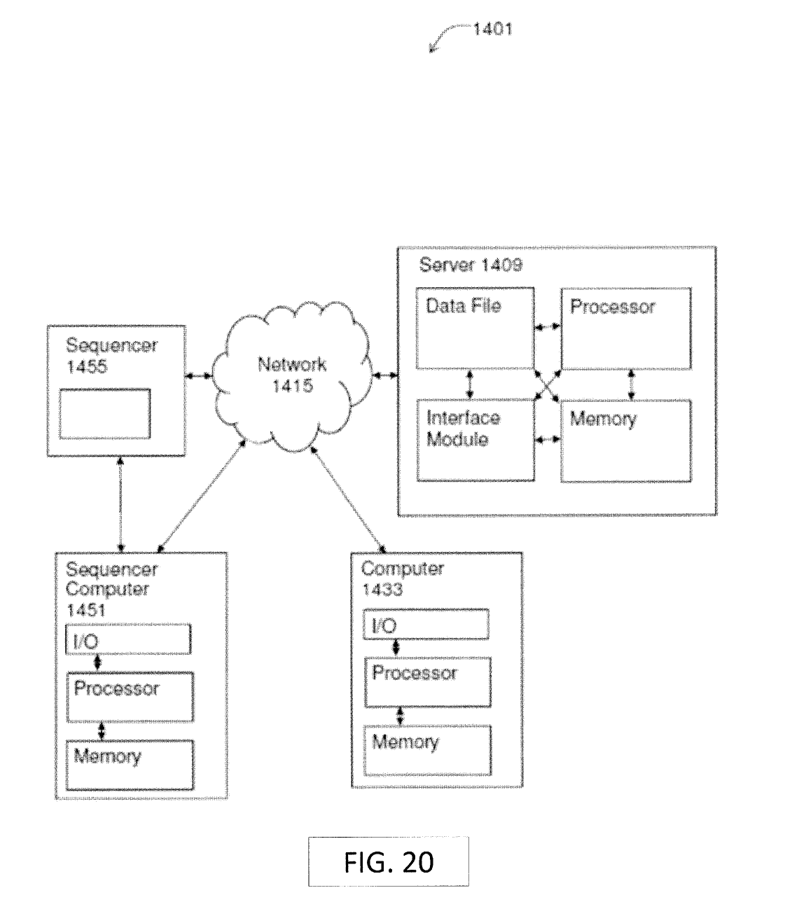

FIG. 18 illustrates a system for assisted local alignment, according to an exemplary embodiment.

### DETAILED DESCRIPTION

Certain exemplary embodiments will now be described to provide an overall understanding of the principles of the structure, function and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Systems and methods are provided herein for assisted local alignment of query data to reference data. In some example embodiments presented herein, the query data is a sequence read and the reference data is reference genome sequence data stored and representable as an SVG. The reference data includes at least a reference or base string. The reference data may include one or more variations of the reference or base string. Each of the strings is represented on the SVG as a path made up of interconnected objects (e.g., nodes, edges) that store a respective portion of the reference data. A search index of the reference data represented by the SVG is generated to allow for efficient searching. The sequence read selected to be aligned may be segmented into k-mers or blocks, which are continuous data subsequences of the sequence read. A search of the reference data represented in the SVG is performed using a global search algorithm to identify matching blocks (e.g., seeds), which are blocks of the sequence read that are found in the search index of the reference data. The matching blocks are analyzed to identify candidate regions in the SVG. Candidate regions are portions of or areas in the SVG that have a substantial number of matching blocks, such that they imply an increased likelihood of being related to the sequence read or portions thereof. Assisted local alignment processes each candidate region by identifying seeds therein and applying a local aligner to (1) portions of the sequence read between the matching blocks, and (2) portions of the candidate region between the matching blocks. Assisted local alignment reduces the amount of data to align by applying local alignment techniques only to those selected areas between matching blocks—not to the matching blocks themselves, since matching blocks are already aligned. Alignment results are generated by concatenating seeds and the aligned portions therebetween.

It should be understood that although exemplary embodiments herein describe assisted local alignment and other processes in connection with an SVG, any other graph or linear reference with which reference data is associated may be used.

It should also be understood that although exemplary embodiments herein describe assisted local alignment and other processes in connection with genome sequence data (e.g., reference sequence, sequence variations, sequence read), other types of data may be used. That is, assisted local alignment as described herein can be applied to any general-purpose approach to improving the performance of short-long sequence alignment algorithms. For example, assisted local alignment as described herein can be used to improve the performance of Web-search algorithms that utilize fuzzy string alignment. In such embodiments, reference data may be any set of data (e.g., strings, text, etc.) such as a dictionary, an encyclopedia, data corresponding to a particular network, database, or the like; while query data may be any data which is used to find matches or similarities therewith within the reference data.

Graph Data Structures

Aspects of the invention relate to the use of a reference graph that represents sequences from one or more known references. In some example embodiments presented herein, a reference graph may be a sequence variation graph (SVG) or a directed acyclic graph (DAG). An SVG refers to data that can be presented as a graph, as well as to a graph that presents that data. The systems and methods described herein, in some example embodiments, provide for the creation and management of an SVG that is stored as data that can be read by a computer system for bioinformatics processing or for presentation as a graph.

In embodiments described herein, the SVG represents a genomic sequence (e.g., a human chromosome) and known variations in the genomic sequence. The SVG is made up of graph elements containing or carrying data subsequences in corresponding carrier payloads (e.g., locations in memory storing those data subsequences and associated with those elements of the graph). The SVG includes a plurality of locations, which refer to unique positions of its graph elements' data subsequence in the SVG. The number of locations in the SVG is the sum of the lengths of all data subsequences carried by its graph elements. For example, in an SVG that represents a nucleotide reference sequence, a location can refer to a specific nucleotide in a data path. Two graph elements have adjacent locations if their data subsequences are adjacent in at least one sequence variation generated by the graph, such as in the case of a single nucleotide polymorphism (SNP).

Substrings or subsequences of the genomic sequence and variations of those sequences or subsequences, which are contained in the graph elements of the SVG, can be stored as objects (e.g., vertex (or node) objects and edge objects) connected to one another to form a plurality of paths through the SVG. SVGs can be referred to as either being “vertex-based” or “edge-based,” depending on whether the data subsequences are associated with vertices or edges, respectively. Each vertex of the SVG is either a source vertex, a sink vertex, or an internal vertex, all of which are connected by edges. An SVG that has m sources and n sinks is referred to as an “(m,n)-SVG”.

Vertices and edges make up paths in the SVG, such that every edge and every vertex in a graph belongs to at least one path along the SVG. Paths refer to portions of the SVG that include continuous or adjacent graph elements. The SVG includes a base path and, optionally, one or more data paths. A base path is a uniquely identified path of the SVG that (1) goes from a source vertex to a sink vertex, and (2) does not include the same graph element more than once. Typically, the base path of an SVG representing a genome will be a reference sequence, such as the GRCh38 human genome assembly; data paths will then represent variations of that reference sequence. The length of a path refers to the number of locations on the path. Paths may further have location offsets that describe the number of locations from the beginning of the path to a specific location in the path. An SVG branch is an aggregate of all directed paths that begin with the same outgoing or end with the same incoming edge connected to a given vertex. The total number of branches for a vertex is the same as the total number of edges connected to the vertex. A vertex in an SVG that has more than one incoming or more than one outgoing branch is called a branching point.

The SVG can be saved in any suitable format including, for example, a list of vertices and edges, a matrix or a table representing a matrix, in a language built with syntax for graphs, in a general markup language purposed for a graph, or others. In one embodiment in which the SVG is stored as a list of vertices and edges, a text file is created that includes all vertices, with an ID assigned to each vertex, and all edges, each with the vertex ID of starting and ending vertex. Thus, for example, an SVG representing two sentences, “See Jane run,” and “Run, Jane run,”, may be stored in a case-insensitive text file or similar format that includes comma-separated values. Naming this SVG “Jane” for future reference, in this format, the SVG “Jane” may read as follows: 1 see, 2 run, 3 jane, 4 run, 1-3, 2-3, 3-4. One of skill in the art will appreciate that this structure is easily applicable to genomic sequences, and the accompanying discussion below.

In certain embodiments, an SVG is stored as a table representing a matrix (or an array of arrays or similar variable structure representing a matrix) in which the (i, j) entry in the N×N matrix denotes that vertex i and vertex j are connected (where N is a vector containing the vertices in genomic order). For an SVG that is acyclic, all non-zero entries must be above the diagonal (assuming vertices are represented in genomic order). In a binary case, a 0 entry represents that no edge exists from vertex i to vertex j, and a 1 entry represents an edge from i to j. One of skill in the art will appreciate that a matrix structure allows values other than 0 to 1 to be associated with an edge. For example, any entry may be a numerical value indicating a weight, or a number of times used, reflecting some natural quality of observed data in the world. A matrix can be written to a text file as a table or a linear series of rows (e.g., row 1 first, followed by a separator, etc.), thus providing a simple serialization structure.

One useful way to serialize a matrix SVG would be to use comma-separated values for the entries, after defining the vertices. Using this format, the SVG “Jane” would include the same vertex definitions as for above, followed by matrix entries. This format could read as:

1 see, 2 run, 3 jane, 4 run

,,1,\,,1, \,,,1\,,,

where entries of zero (0) are simply omitted and ‘\’ is a newline character.

Embodiments of the invention include storing an SVG in a language built with syntax for graphs. For example, The DOT Language provided with the graph visualization software packages known as Graphviz provides a data structure that can be used to store an SVG with auxiliary information and that can be converted into graphic file formats using a number of tools available from the Graphviz web site. Graphviz is open source graph visualization software. Graph visualization is a way of representing structural information as diagrams of abstract graphs and networks. It has applications in networking, bioinformatics, software engineering, database and web design, machine learning, and in visual interfaces for other technical domains. The Graphviz layout programs take descriptions of graphs in a simple text language, and make diagrams in useful formats, such as images and scalable vector graphics for web pages; PDF or Postscript for inclusion in other documents; or display in an interactive graph browser.

In related embodiments, an SVG is stored in a general markup language purposed for a graph. Following the descriptions of a linear text file, or a comma-separated matrix, above, one of skill in the art will recognize that a language such as XML can be used (e.g., extended) to create labels (e.g., markup) defining vertices and their headers or IDs, edges, weights, etc. However an SVG is structured and stored, embodiments presented herein describe using vertices to represent genomic sequences with edges connecting the vertices to create paths through the SVG that represent genome-scale genomic sequences.

In an exemplary embodiment, a library is developed that provides core elements of genome graph representation as well as manipulation routines. For example, library elements can be developed in a language that provides for low-level memory manipulation such as C++ and compiled to provide binary elements. A genomic SVG may be represented as a set of edge and vertex objects linked to each other.

To represent the graph, adjacency lists may be used wherein vertices and edges are stored as physical objects. A vertex or edge stores lists of edges/vertices that it is adjacent to. In certain embodiments, nucleotide sequences and metadata are stored in edge objects. The usage of adjacency lists simplifies local graph traversal. Adjacency lists prove to be a very efficient way to represent a genomic SVG. The genomic-scale reference SVG, when implemented using computer-executable instructions, can effectively leverage specifics of hardware memory addressing for creating efficient adjacency lists. For example, the implementation of a genomic-scale genomic reference SVG can call native pointers to adjacent edge/vertex objects from the hardware level. The library elements can include a hash table and search algorithm for efficient searching of k-mers (sequence fragments) in the graph while maintaining a very small memory footprint. Through the use of a hash table, the average cost for a lookup may be made to be independent of the number of elements stored in the table. Additionally, the hash table can be implemented to allow for arbitrary insertion or deletion of entries. Use of pointers significantly improves operation for traversing paths through a genomic SVG to retrieve sequence strings or to perform alignments (which traversal operation have traits in common).

In some embodiments, the pointer or native pointer is manipulatable as a memory address in that it points to a physical location on the memory but also dereferencing the pointer accesses intended data. That is, a pointer is a reference to a datum stored somewhere in memory; to obtain that datum is to dereference the pointer. The feature that separates pointers from other kinds of reference is that a pointer's value is interpreted as a memory address, at a low-level or hardware level. The speed and efficiency of the described graph genome engine allows whole genome short-read alignments to be made on genomic-scale genomic reference SVGs containing variant data from thousands of samples, using commercially available, off-the-shelf desktop systems. Such a graph representation provides means for fast random access, modification, and data retrieval. The library can also include and support a universal graph genome coordinate system. The compactness of the graph representation allows the whole human genome along with variants from typical variant databases such as dbSNP to be held and used within the limitations of modern consumer-grade computer systems.

In some embodiments, fast random access is supported and graph object storage are implemented with index-free adjacency in that every element contains a direct pointer to its adjacent elements (e.g., as described in U.S. Pub. 2014/0280360 and U.S. Pub. 2014/0278590, incorporated by reference), which obviates the need for index look-ups, allowing traversals (e.g., as done in the modified SW alignment algorithm described herein) to be very rapid. Index-free adjacency is another example of low-level, or hardware-level, memory referencing for data retrieval (as required in alignment and as particularly pays off in terms of speed gains in the modified, multi-dimensional Smith-Waterman alignment described herein). Specifically, index-free adjacency can be implemented such that the pointers contained within elements are in-fact references to a physical location in memory.

Since a technological implementation that uses physical memory addressing such as native pointers can access and use data in such a lightweight fashion without the requirement of separate index tables or other intervening lookup steps, the capabilities of a given computer, e.g., any modern consumer-grade desktop computer, are extended to allow for full operation of a genomic-scale SVG (i.e., a reference structure that includes not only a complete human genome but also all of the variation in that genome represented in a database such as dbSNP or all of variation discovered by re-sequencing one or more full genomes). Thus storing graph elements (e.g., vertices and edges) using a library of objects with native pointers or other implementation that provides index-free adjacency—i.e., embodiments in which data is retrieved by dereferencing a pointer to a physical location in memory—actually improves the ability of the technology to provide storage, retrieval, and alignment for genomic information since it uses the physical memory of a computer in a particular way.

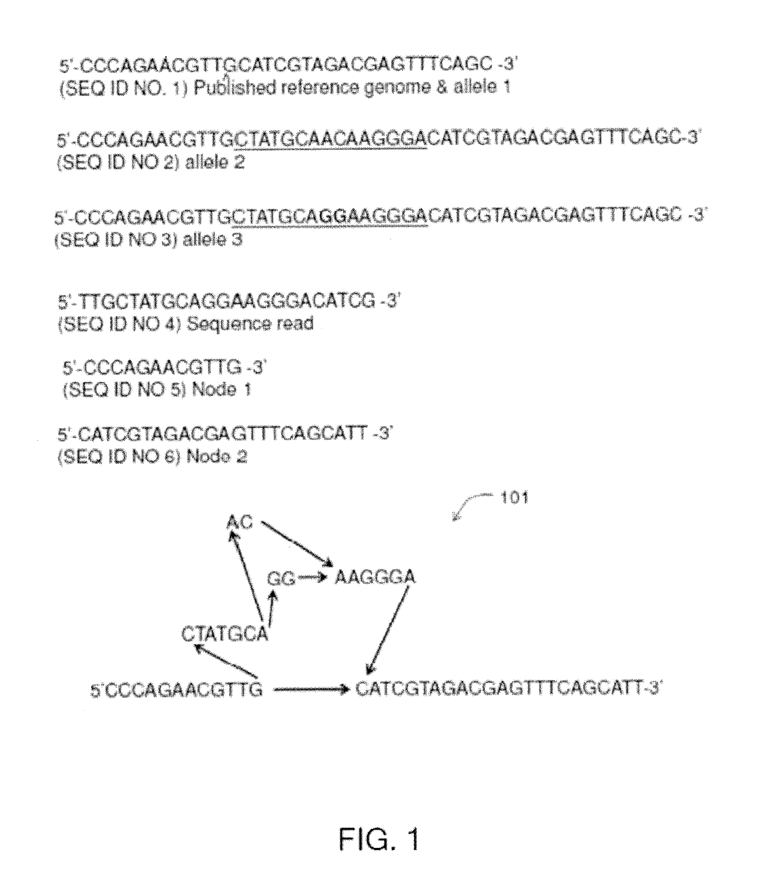

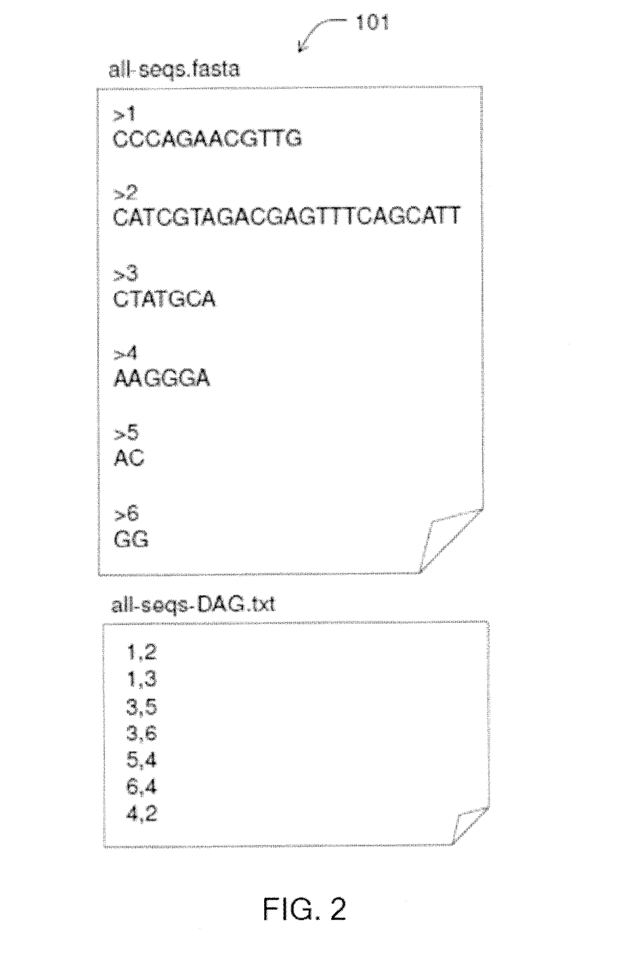

While no specific format is required for storage of an SVG, FIGS. 1 and 2 are presented to illustrate one convenient and compact format that is useful for illustrations (remembering that in an exemplary embodiment, graph objects are stored with index-free adjacency with metadata stored separately to speed traversals and alignments). In illustrations below, exemplary SVGs are presented and discussed as graphs, but it will be appreciated that an SVG can be translated directly to a data structure in computer memory or a text document and back. Further, while the present disclosure describes the use of SVGs, any graph data structure may be used, including non-directed or non-acyclic graphs, or combinations thereof.

FIG. 1 illustrates using an SVG 101 to represent and manipulate bioinformatic data, such as a plurality of nucleotide sequences. To reveal the contents of SVG 101, FIG. 1 also includes linear listings of a set of hypothetical sequences, each of which are paths through SVG 101. A hypothetical published reference (this could be, for example, the actual genomic DNA from the person from Buffalo, N.Y. that contributed to the “human genome”) is included and represents allele 1:

(SEQ ID NO. 1)
5′-CCCAGAACGTTGCATCGTAGACGAGTTTCAGC-3′

A second allele is included (allele 2) that varies from allele 1 by a 15 bp indel (underlined below):

(SEQ ID NO: 2)
5′-CCCAGAACGTTGCTATGCAACAAGGGACATCGTAGACGAGTTTCA
GC-3′

A third allele (allele 3) is also included that matches allele 2 but for a polymorphism in the middle of the indel (in bold) at which an AC from allele 2 is presumptively homologous to a GG in allele 3:

(SEQ ID NO: 3)
5′-CCCAGAACGTTGCTATGCAGGAAGGGACATCGTAGACGAGTTTCA
GC-3′

A hypothetical sequence read (described in further detail below) from a subject is included:

(SEQ ID NO: 4)
5′-TTGCTATGCAGGAAGGGACATCG-3′

In the depicted scenario, the sequence read from the subject has the GG polymorphism (and thus the subject has the GG polymorphism). If the sequence read was aligned to the published reference genome, it would not be discovered that the GG polymorphism represented two consecutive substitutions relative to allele 2. Instead, many existing alignment or assembly algorithms would find no good alignment between the sequence read and the published reference and may even discard that read as failing to satisfy a quality criterion.

Under embodiments described herein, an SVG 101 is constructed. Edge 1 is instantiated as 5′-CCCAGAACGTTG-3′ (SEQ ID NO: 5) . Edge 2 is created as 5′-CATCGTAGACGAGTTTCAGCATT-3′ (SEQ ID NO: 6) . Edge 3 is CTATGCA. Edge 4 is AAGGGA. Edge 5 is AC and edge 6 is GG. It is worth noting that in some embodiments, mapping sequence reads to an SVG involves creating a new edge to represent data in the reads not yet in the SVG.

For example, prior to read mapping, SVG 101 may not yet include edge 6 (GG). The alignment algorithm (discussed below in further detail) finds that the sequence read best matches the path for allele 2 that connects edges 1→3→5→4→2, as depicted in FIG. 1. To correctly represent the sequence read, new edge 6 is created, and the sequence read is thus represented within SVG 101 by the path that connects edges 1→3→6→4→2. It will be appreciated that prior to this mapping, edges 3, 5, and 4 need not yet exist as separate vertices. Mapping the sequence read and creating the new edge 6 can include breaking up a prior edge of (3+5+4) into edges 3, 5, and 4. That is one of the powerful benefits of using an SVG as a reference—read mapping is not a simple exercise in comparison to a reference, but can include building the reference to represent all known genotypes including novel genotypes only yet documented by new sequence reads.

FIG. 2 shows one possible format of an SVG 101 suited to computational storage and retrieval. SVG 101 as represented in FIG. 2 presents the same topology and sequences as the graphical version depicted in FIG. 1. Here, the depicted format is useful because the nucleotide sequences associated with the vertices are stored as a FASTA file, which is familiar in the art of bioinformatics (and could just as easily be a FASTQ file). The edges can be stored in a text file, here as a simple list.

Arbitrary paths through SVG 101 represent a Markov process as depicted in FIGS. 1 and 2, in that, from any vertex, upstream vertices are independent of downstream vertices. However, due to genetic conservation, linkage disequilibrium, non-uniform GC content, and other biological phenomenon, following a biologically supported path from vertex to vertex through a genomic SVG to represent an actual genome is likely non-Markovian.

A reference SVG can represent a very large number of known variations for a particular genome (or a large number of complete genomes) and methods of the invention can be used to quickly identify a suitable portion or portions (e.g., candidate regions) of one or a few of those variations or genomes to which a sequence read should be aligned. Indexing collections of data strings such as nucleotide and protein sequences represented in a form of graphs such as an SVG, and performing efficient searching on the collection including exact and approximate matching techniques, are now described. Among other applications, these methods can be used to quickly and efficiently find candidate regions for aligning sequence reads (e.g., produced by DNA sequencing machines) to reference graphs (e.g., SVGS) representing genome sequence data and data variations.

To identify candidate alignment regions, many small sections, or k-mers, of the SVG can be put into a computer hash function. The hash function calculates an index as a function of the k-mer. The index identifies an entry in a hash table, and the positions of the k-mer within the SVG are stored in that entry, i.e., in the entry indexed by the hash of the k-mer. A sequence read is analyzed by hashing some or all of its k-mers and the corresponding entries of the SVG hash table are accessed to read positions within the SVG where those sequence read k-mers can be found. Sections of the SVG where a threshold number of k-mer positions are found are identified as candidate regions within the represented genomes for alignment or mapping of the sequence read. By the described implementation, a sequence read can be mapped to a “good fit” position within a very large number of reference genomes very rapidly.

The following describes one example embodiment of a method for indexing and subsequently searching a genomic SVG. Among other applications, the described embodiment can be used to quickly and efficiently identify candidate regions of a reference SVG to which one might attempt to align sequence reads by way of assisted local alignment using a local alignment tool such as the modified Smith-Waterman algorithm described below. In the described embodiment, a search index is built, after which the search index is searched for candidate regions for local alignment.

### Building a Search Index

Populating a hash table for use as a search index corresponding to an SVG can be performed in the following manner. Building the search index may include identifying a plurality of paths through a reference graph, each path representing a concatenation of the sub strings or data strings of a genomic sequence and known variations in the genomic sequence stored in objects through the path. In particular, two parameters, S and B, are used to segment data strings from a genome graph into a plurality of k-mers, or blocks. (The terms “k-mer” and “block” are used interchangeably in the disclosure to refer to a portion of data from a data sequence or subsequence.)

First, each path of a plurality of paths through a reference graph or SVG is traced. Tracing of a path results in the identification of a data string (e.g., a nucleotide sequence represented by the path traced), which is added to a collection of data strings for the graph.

Second, for every S-th position of the data strings identified, a hash index and a location identifier are determined for a block of B symbols starting at this position. In this embodiment, the hash index is an unsigned integer number, which is a digest of block data used to verify block data identity. The location identifier can be some information that identifies the exact or approximate position, or location, of the block within the graph (typically, the position of the first symbol in the block). For example, the location identifier could be an offset of the block, or its number in the path; a projection of the position of the first, last, or middle symbol in the block onto a particular path (such as the base path) of the graph calculated according to a certain rule; a coordinate of a block's first, last, or middle symbol in a particular graph coordinate system; or any other means of identifying locations within a graph.

Third, the search index is created by listing each identified block's location within the graph in an entry in a table. The table provides hash values of each block and the location identifiers associated with each unique block. Because different paths may contain the same graph edges or portions of the graph, positions of blocks located entirely inside vertices or edges that have already been indexed as parts of other paths are excluded from indexing. For each identified block, the block location identifier is added to the list of location identifiers corresponding to those previously determined (e.g., in step 2). Thus, each entry is indexed according to a hash of that block and contains locations of all blocks having that index.

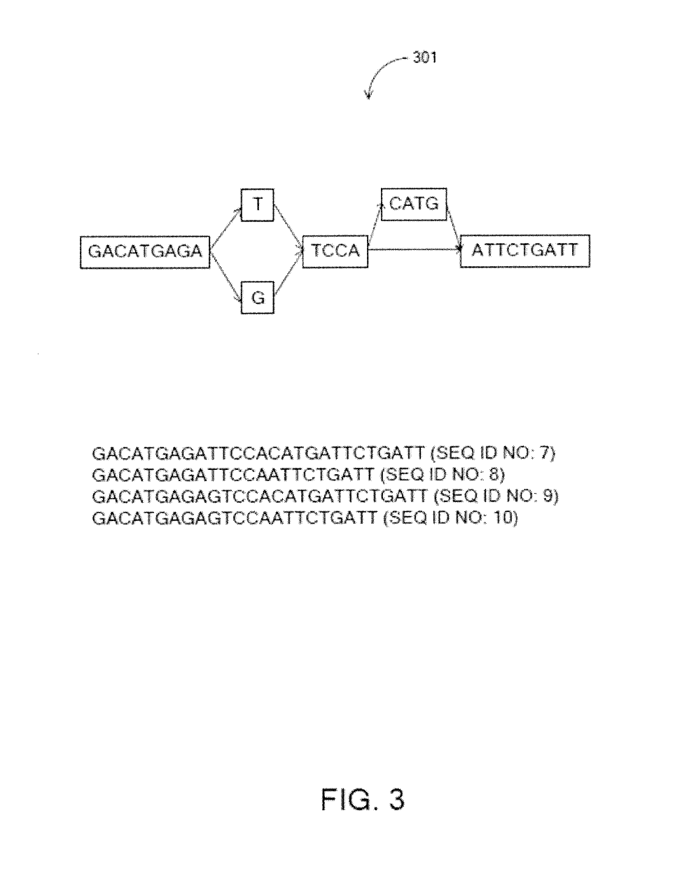

FIG. 3 provides an illustration of a genome graph or SVG 301, and Table 1 below provides its corresponding search index using parameters S=2 and B=3. In FIG. 3, four strings are represented by the graph, as follows (positions of variation shown in bold):

(SEQ ID NO: 7)
GACATGAGAGTCCAATTCTGATT
(SEQ ID NO: 8)
GACATGAGATTCCAATTCTGATT
(SEQ ID NO: 9)
GACATGAGAGTCCACATGATTCTGATT
(SEQ ID NO: 10)
GACATGAGATTCCACATGATTCTGATT

In this example embodiment, the location identifiers for blocks in the graph are determined by calculating an offset from the left-most or first position (e.g., position 0) in the graph (here, representing the nucleotide “G”). Each successive block is assigned an integer location identifier that is incremented by one. Note that as the graph is a multi-dimensional structure, blocks from different data strings may have the same location identifier. However, in certain embodiments, location identifiers may use floating point projections or other means to highlight alternate edges which would have the same offset from the first position in the graph. For example, blocks corresponding to separate paths in the graph could have location identifiers “9” and “9.1”, the former representing a reference path and the latter representing an alternate branch. The use of floating point projections is discussed in further detail below.

To build the search index with parameters S=2 and B=3, the first block of B number of nucleotides starting from the first position is identified. That block, or k-mer, is “GAC,” and the location identifier for this block is 1. Remembering that every S-th position is to be examined and S=2, the indexing moves forward along the SVG in FIG. 3 from “GAC” to the block “CAT.” As the second block identified, the location identifier for block “CAT” is 2.

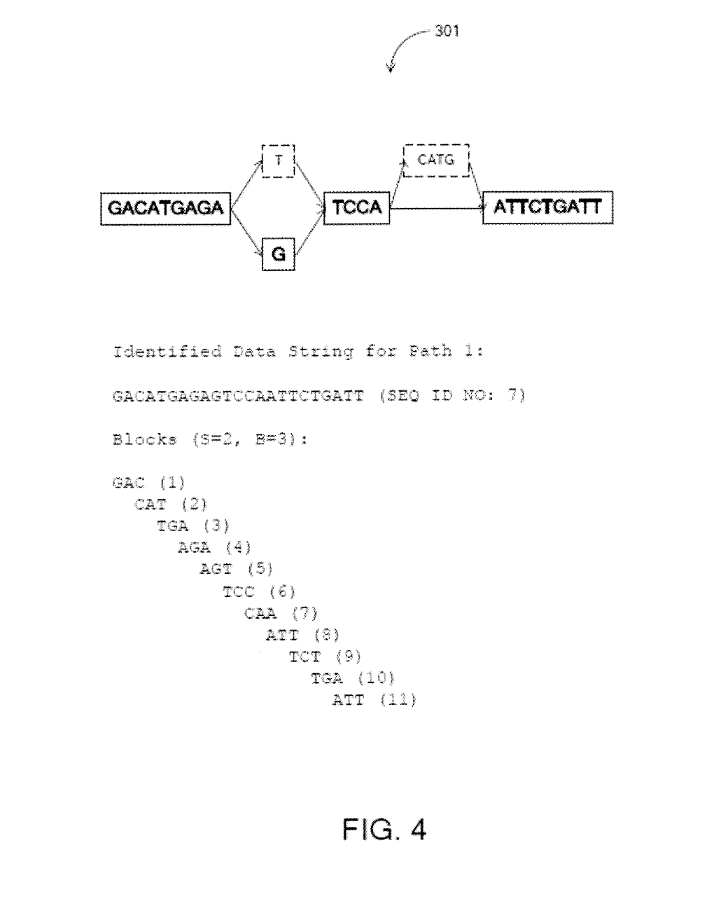

FIG. 4 illustrates the generation of blocks for a first path through the SVG 301 in more detail. In particular, FIG. 4 illustrates the blocks generated from a first of four paths that can be traced through the SVG 301. The first path is highlighted in bold and identifies the data string GACATGAGAGTCCAATTCTGATT (SEQ ID NO: 7). In this example, this path is referred to as the base path of the SVG 301. In some embodiments, the data string represented by the base path data could represent the canonical reference sequence of a genome. As shown in connection with FIG. 4, 11 blocks are identified having location identifiers from 1 to 11. Each block comprises a 3-symbol (B=3) sequence taken from every two positions within the data string.

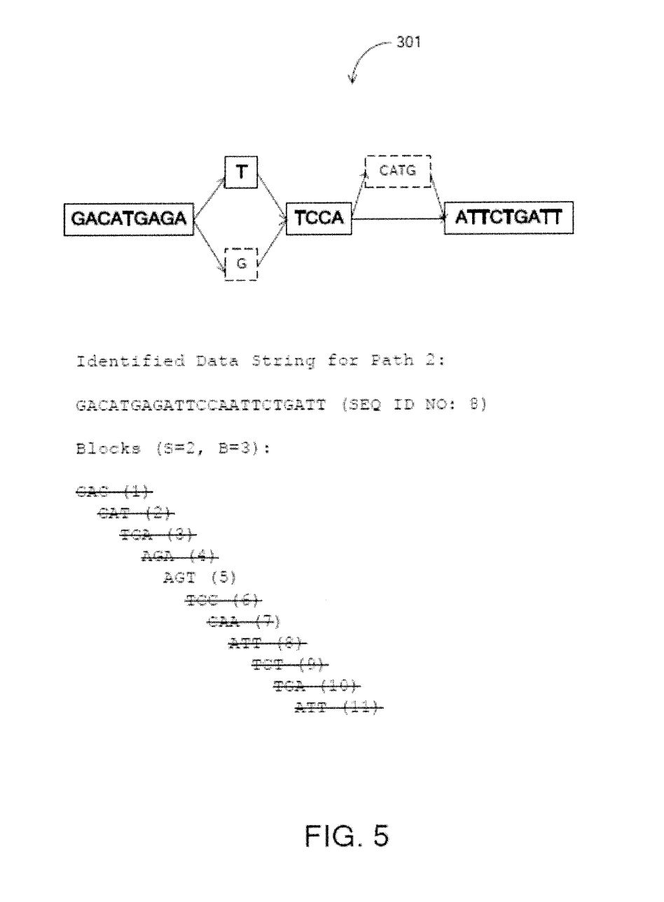

FIG. 5 illustrates the generation of blocks for a second path through the SVG 301. The second path is highlighted in bold and identifies the data string GACATGAGATTCCAATTCTGATT (SEQ ID NO : 8). Similar to the first path, 11 blocks are identified. However, several of the blocks overlap—meaning that the second path includes blocks that are the same data subsequence represented in the first path. These overlapping blocks (shown with strike-out font in FIG. 5) are redundant and may be removed from a subsequent indexing step. As shown, only block “AGT” having location identifier 5 is new in the second data string.

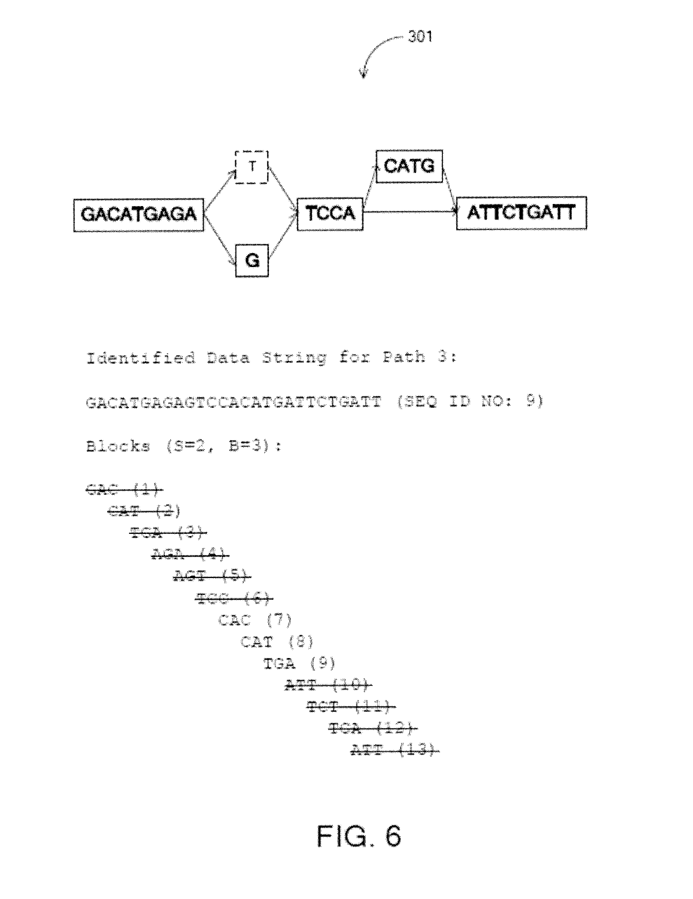

FIG. 6 illustrates the generation of blocks for a third path through the SVG 301. The third path is highlighted in bold and identifies the data string GACATGAGAGTCCACATGATTCTGATT (SEQ ID NO : 9 . Three new blocks are identified in the data string represented by the third path: “CAC” (7), “CAT” (8), and “TGA” (9). Because they are new, these blocks are not excluded from indexing. Finally, FIG. 7 illustrates the generation of blocks for a fourth and final path through the SVG 301, identifying the data string GACATGAGATTCCACATGATTCTGATT (SEQ ID NO: 10). The fourth path includes no new blocks.

Once all of the blocks and location identifiers for the graph have been identified, a search index is created that includes a hash index for the symbols of each unique block and the associated location identifiers for that unique block. For each of these blocks a hash index is calculated, represented in Table 1 as “hash(AGA)” and “hash(AGT)”. A hash index is calculated using a hash function, which is a function that uses a block, or k-mer, as a key, and turns the key into an array index. One suitable method for hashing strings is to map each key to a big integer, e.g., by treating characters of the string of the key as “digits” in a base-a number system, where a is the size of the alphabet in which the string is written. This results in an integer. Where the resulting integers are large enough to exceed the number of slots m in the hash table, this can be addressed by methods that include dividing the integer by a prime and using the remainder (which will distribute the hash values over the m slots). Hash functions are known in the art and are provided within a variety of development environments or languages including Java, Perl, bioPerl, Ruby, bioRuby, C++, etc. In some example embodiments and particularly in C and C++, the hash function produces a hash of the value of the block, which hash is the memory address.

Since the hash of a string is an index for an entry in a table, the entry is a place to store information. In the described embodiment, the entry stores the location identifiers for the k-mer that is hashed. Since B=3 and the alphabet for the blocks, or k-mers, is A, T, G, and C, a total of 64 unique blocks are possible. Thus the hash table includes 64 entries. For larger values of B, the number of possible unique blocks is 4^{B}. Preferably the hash of NNN where NE {A, T, G, C} is an integer from 0 to 63 inclusive. That is, in some embodiments, hash(AAA)=0, hash(AAC)=1, hash(AAG)=2, etc., but the precise hash function is not strictly important. In certain embodiments, a built-in hash function is used. The hash value is not represented in Table 1, instead it is being given as “hash(AGA)” or similar.

Table 1 presents a hash table for the SVG in FIG. 3 with S=2 and B=3.

TABLE 1

| Hash Index | Location Identifiers |
|---|---|
| Hash (AGA) | 4 |
| Hash (AGT) | 5 |
| Hash (ATT) | 5, 8, 11 |
| Hash (CAA) | 7 |
| Hash (CAC) | 7 |
| Hash (CAT) | 2, 8 |
| Hash (GAC) | 1 |
| Hash (TCC) | 6 |
| Hash (TCT) | 9 |
| Hash (TGA) | 3, 9, 10 |

In practice, a 1:1 correspondence between unique blocks and hash indices (as depicted in the above example) may not always be feasible given memory constraints. For example, for B=20 and a 4-symbol alphabet (the typical alphabet size for the majority of genomic applications), 4̂20 indices would be needed, which is far beyond the typical allowance. Therefore, in practice, one may have to use hash functions that do not guarantee 1:1 mapping. The latter may result in hash collisions.

### Global Searching

The methods and systems described herein provide for global searching by mapping query sequences, such as sequence reads, to a reference graph, such that candidate regions in a graph can be efficiently located and, in turn, aligned to the sequence read. Although described below in further detail, it should be understood that candidate regions refer to a substring or subsequence of a path within a graph for which there is evidence of a meaningful relationship, such as a homology, identity, or duplication between the sequence read and the candidate region.

Exemplary methods for obtaining sequence reads are now discussed, though it should be understood that any subject sequence can be mapped to an SVG including, for example, sequence reads, gene sequences or subsequences, artificial sequences, substrings or entire sequences retrieved in silico (e.g., from GenBank or from the SVG itself), etc.

In certain embodiments, sequence reads are obtained by performing sequencing on a sample from a subject. Sequencing may be performed using any method known in the art. See, generally, Quail, et al., 2012, A tale of three next generation sequencing platforms: comparison of Ion Torrent, Pacific Biosciences and Illumina MiSeq sequencers, BMC Genomics 13:341. DNA sequencing techniques include classic dideoxy sequencing reactions (Sanger method) using labeled terminators or primers and gel separation in slab or capillary, sequencing by synthesis using reversibly terminated labeled nucleotides, pyrosequencing, 454 sequencing, Illumina/Solexa sequencing, allele specific hybridization to a library of labeled oligonucleotide probes, sequencing by synthesis using allele specific hybridization to a library of labeled clones that is followed by ligation, real time monitoring of the incorporation of labeled nucleotides during a polymerization step, polony sequencing, and SOLiD sequencing.

One exemplary sequencing technique uses sequencing-by-synthesis systems sold under the trademarks GS JUNIOR, GS FLX+ and 454 SEQUENCING by 454 Life Sciences, a Roche company (Branford, Conn.), and described by Margulies, M. et al., Genome sequencing in micro-fabricated high-density picotiter reactors, Nature, 437:376-380 (2005); U.S. Pat. No. 5,583,024; U.S. Pat. No. 5,674,713; and U.S. Pat. No. 5,700,673, the contents of which are incorporated by reference herein in their entirety. 454 sequencing involves two steps. In the first step of those systems, DNA is sheared into blunt-end fragments of approximately 300-800 base pairs attached to DNA capture beads and then amplified within droplets of an oil-water emulsion. In the second step, pyrosequencing is performed on each DNA fragment in parallel. Addition of one or more nucleotides generates a light signal that is recorded by a CCD camera in a sequencing instrument.

Another example of a DNA sequencing technique that can be used is SOLiD technology by Applied Biosystems from Life Technologies Corporation (Carlsbad, Calif.). In SOLiD sequencing, genomic DNA is sheared into fragments, and adaptors are attached to the 5′ and 3′ ends of the fragments to generate a fragment library. Clonal bead populations are prepared in microreactors containing beads, primers, template, and PCR components. Following PCR, the templates are denatured and enriched and the sequence is determined by a process that includes sequential hybridization and ligation of fluorescently labeled oligonucleotides.

Another example of a DNA sequencing technique that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., An integrated semiconductor device enabling non-optical genome sequencing, Nature 475:348-352 (2011); U.S. Pubs. 2009/0026082, 2009/0127589, 2010/0035252, 2010/0137143, 2010/0188073, 2010/0197507, 2010/0282617, 2010/0300559, 2010/0300895, 2010/0301398, and 2010/0304982, each incorporated by reference. DNA is fragmented and given amplification and sequencing adapter oligos. The fragments can be attached to a surface. Addition of one or more nucleotides releases a proton (H³⁰ ), which signal is detected and recorded in a sequencing instrument.

Another example of a sequencing technology that can be used is Illumina sequencing. Illumina sequencing is based on the amplification of DNA on a solid surface using fold-back PCR and anchored primers. Genomic DNA is fragmented and attached to the surface of flow cell channels. Four fluorophore-labeled, reversibly terminating nucleotides are used to perform sequential sequencing. After nucleotide incorporation, a laser is used to excite the fluorophores, and an image is captured and the identity of the first base is recorded. Sequencing according to this technology is described in U.S. Pub. 2011/0009278, U.S. Pub. 2007/0114362, U.S. Pub. 2006/0024681, U.S. Pub. 2006/0292611, U.S. Pat. No. 7,960,120, U.S. Pat. No. 7,835,871, U.S. Pat. No. 7,232,656, U.S. Pat. No. 7,598,035, U.S. Pat. No. 6,306,597, U.S. Pat. No. 6,210,891, U.S. Pat. No. 6,828,100, U.S. Pat. No. 6,833,246, and U.S. Pat. No. 6,911,345, each incorporated by reference.

Other examples of a sequencing technology that can be used include the single molecule, real-time (SMRT) technology of Pacific Biosciences (Menlo Park, Calif.) and nanopore sequencing as described in Soni and Meller, 2007 Clin Chem 53:1996-2001.

Sequencing generates a plurality of reads or sequence reads. Sequence reads in some embodiments include sequences of nucleotide data less than about 600 or 700 bases in length, although it should be understood that embodiments described herein may be applicable to reads or sequence information of any length including, e.g., reads of <150 bases or even less than 50, as well as greater than 700, e.g., thousands of bases in length.

Whatever the sequence read, once the sequence read has been obtained, it may be used to search a search index of a reference graph—made as described above—to locate regions within the graph that are candidates for assisted local alignment or mapping of the subject sequence. That is, in example embodiments described herein, after a search index is built, the search index is used to search for candidate regions for local alignment. Searching the index for candidate regions for local alignment can include any suitable method. In some example embodiments, searching includes hashing the sequence read at a plurality of positions and using the resulting hashes to retrieve graph location identifiers from the search index.

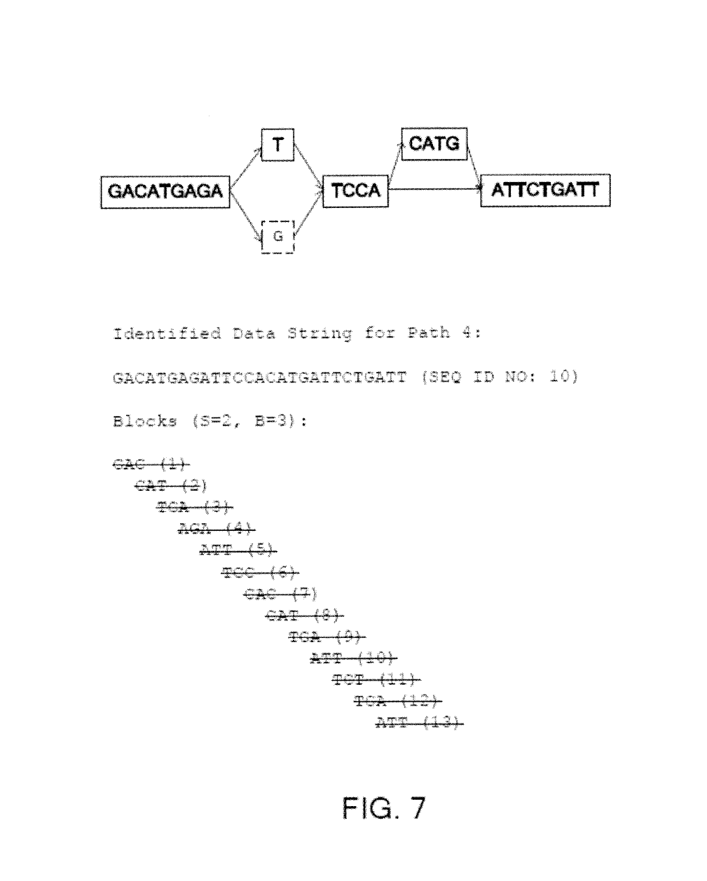

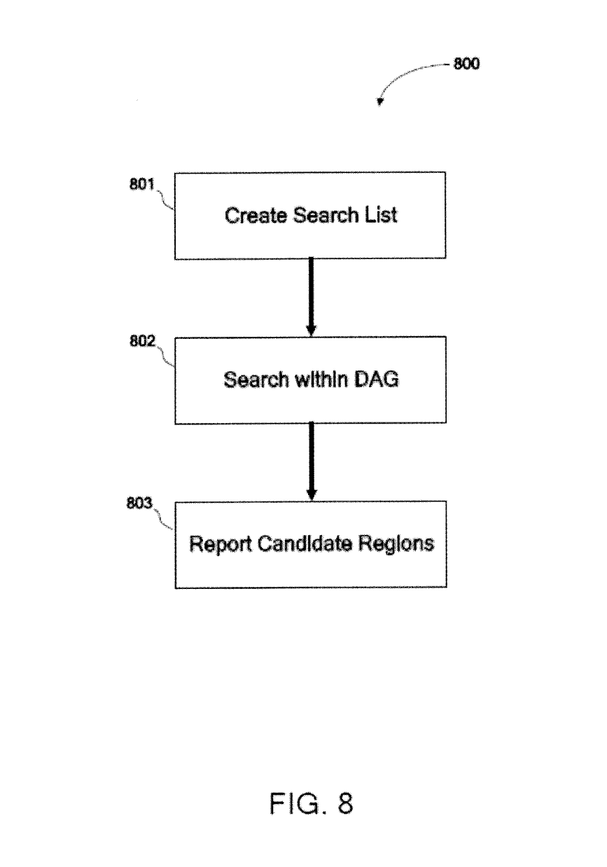

To identify candidate regions in a reference graph, the obtained sequence read is mapped to the reference graph. FIG. 8 illustrates a method 800 of mapping a subject sequence to an SVG using a search index. The method 800 of mapping a subject sequence to an SVG includes creating a search list (step 801), searching within the SVG (using the search index) (step 802), and locating and/or reporting candidate regions (step 803).

Creating a “search list” of hash lists (step 801) can be done by identifying a plurality of query k-mers from the query sequence or sequence read. This can include calculating a hash index (or optionally 2 or 4 indices, as previously noted) for each block of B base pairs in the sequence read, and adding to the search list the entry (hash list) in the SVG hash table corresponding to the calculated index. This is the equivalent of the process of creating the search index described above, with S set to 1.

Searching within the SVG (step 802) can be performed by determining the locations of at least one query k-mer within the graph by reading search index entries indexed according to hashes of query k-mers. In turn, searching further includes identifying portions of the graph (or candidate regions) in which the number of potential matches with different query k-mers is equal to or exceeds a threshold number. For example, searching for candidate regions can include looking for regions inside the SVG which (1) are similar or equal in size to the sequence read, and (2) contain a substantial number (e.g., based on a determined threshold number) of block matches with the sequence read. An efficient search process leverages the strict order of location identifiers inside hash lists.

More specifically, one global search procedure that leverages the strict order of location identifiers involves the following steps (SS1) through (SS6). SS1. For each B consecutive symbols of a string being searched for (e.g., a sequence read, etc.), a hash index is calculated by applying the hash function used during the search index construction. A list of block location identifiers for each block in the string corresponding to blocks in the calculated search index is determined. (The maximum number of different lists for a string of size M is M−B+1.) This yields an aggregate of location identifier lists, i.e., a list of location identifiers from the search index for each block identified in the sequence read.

SS2. Blocks and location identifiers belonging to the aggregate of location identifier lists determined in step SS1 are further analyzed in order to find all different substantial subsets of elements that identify locations within limited continuous regions of the SVG that are similar in size to the sequence read. These identified limited continuous regions correspond to candidate regions, which may be subsequently used for assisted local alignment. In other words, candidate regions are regions that satisfy a certain determined length limitation and contain a substantial number of locations identified in the aggregate table as being block matches. Since location identifiers being analyzed correspond to hash indexes of all continuous string subsequences of size B, chances are high that there will be multiple matches between blocks located in a candidate region and blocks of identical size constituting the sequence read. The larger the number of block matches, the higher the probability of a quality string match.

The region size limitation can be determined a priori based on the length of the sequence read. For exact matching or fuzzy matching without symbol insertions or deletions, a candidate SVG region size will be about the size of the sequence read. If insertions and deletions are allowed, the size of the SVG region can be calculated as about the size of the sequence read plus an additional number of symbols that can be inserted in a string of this size.

Since identifier subsets are determined based on location identifier proximity, significant complexity reduction can be achieved by determining the global order of the location identifiers in the aggregate table and sequentially analyzing the location identifiers in order using a “sliding window” approach. FIG. 13 briefly illustrates the sliding window technique. In FIG. 13, a window of size N (e.g., the size of the sequence read) is moved along the reference. An efficient search procedure leverages the strict ordering of location identifiers inside individual location identifier lists when determining the global order. One such procedure is outlined below:

a. An initial set of location identifiers is formed by taking the first-in-order (e.g., lowest value) location identifier from each list of location identifiers determined in step SS1.

b. During the search, the initial set of location identifiers is updated iteratively such that it never includes more than one element from each list of location identifiers identified in step SS1. At each iteration, one of the location identifiers is replaced with the next-in-order location identifier belonging to the same list (i.e., the list that contains the identifier being replaced). This next-in-order identifier is the smallest identifier among all possible next-in-order identifiers, as determined by picking one next-in-order candidate from each list if such identifier exists. Determining the next-in-order identifier can be done easily and efficiently by creating a heap data structure of all the identifiers belonging to the aggregate of location identifier lists determined in step SS1. The top element in the heap is always the next-in-order element being searched for.

c. For each set determined in step SS2.b a maximum number of location identifiers that fall within a continuous SVG region of a certain size is calculated. If the maximum number of location identifiers is above a certain threshold, the SVG region is considered a candidate region.

SS3. Candidate regions identified in step SS2 are further analyzed in order to eliminate false positives. The details of this procedure may differ depending on the specifics of the search algorithm application. Not only the search index, but also the original graph may be used to verify match quality/validity and/or to elaborate on the match details.

SS4. Search results can be reported 803 in a variety of ways. Reporting 803 candidate regions includes reporting location identifiers within the threshold and whether they resulted from matches to “original”, inverted, complementary, or inverted complementary blocks. What type of blocks have been matched is relevant because certain combinations of block types are more biologically plausible than others. For example, when performing assisted local alignment, ideally the blocks are organized in a manner such that they correspond to the 5′-3′ directionality of the sequence read. Optionally, candidates can be reported ranked according to a score based on number of blocks matched and different weights for different types of blocks and combinations. Similarly, search results can be reported in a form of a list of candidate regions, and/or a list of matching graph paths. The report may include the location of the candidate region in the SVG, length of the candidate region, graph path specification, number of block matches, location of the matching blocks, weighted candidate rank, etc.

SS5. (Optional) Search results may be ordered by match quality. For example, candidate region with a higher numbers of block matches or higher weighted candidate ranks are reported first.

SS6. (Optional) For each result reported in step SS4, an additional refining step or steps can be applied in order to obtain more detailed information about the match. When performing DNA sequencing, it may be desirable to apply assisted local alignment procedure right after a global read location has been determined with the use of the described method.

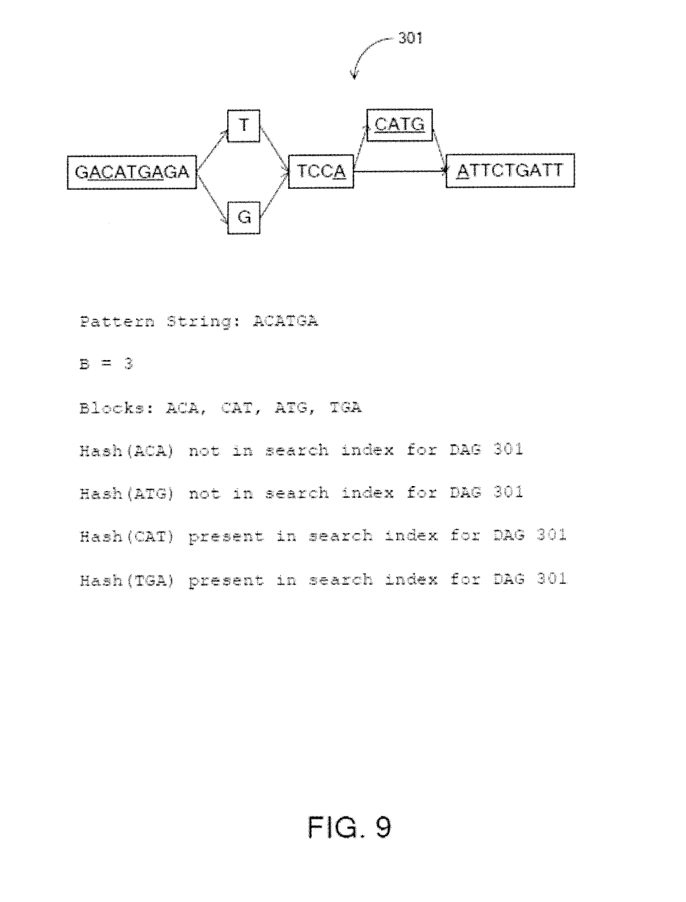

The following example illustrates the described global search procedure, which finds all occurrences of the string ACATGA in the SVG used in the above search index construction example (i.e., using exact string matching). FIG. 9 illustrates the occurrences (underlined) of the pattern string ACATAG in the SVG 301.

Using a block size B=3, the continuous subsequences (e.g., blocks, k-mers) of the string ACATGA are: ACA, CAT, ATG, and TGA. A new table of an aggregate of location identifier lists (from step SS1 above) is created by comparing the location identifiers in the search index for the SVG (in Table 1) with the blocks identified from the sequence read. The location identifiers for hashed indexes are noted in a search list, as shown in Table 2, below:

TABLE 2

| Hash Index | Location Identifiers |
|---|---|
| Hash (ACA) | — |
| Hash (ATG) | — |
| Hash (CAT) | 2, 8 |
| Hash (TGA) | 3, 9, 10 |

The blocks and location identifiers are then analyzed to determine candidate regions for alignment (step SS2). In particular, blocks having location identifiers are identified as block matches, as illustrated by an “X” in Table 3 below. In this example, blocks that occur in sequentially ordered location identifiers are noted as candidate regions for string matching and subsequent local alignment.

TABLE 3

| | Location Identifiers (Global Ordering) | | | | | | | | | |
|---|---|---|---|---|---|---|---|---|---|---|
| Hash Index | 1 | 2 | 3 | 4 | 5 | 6 | 7 | 8 | 9 | 10 |
| Hash (ACA) | | | | | | | | | | |
| Hash (ATG) | | | | | | | | | | |
| Hash (CAT) | | X | | | | | | X | | |
| Hash (TGA) | | | X | | | | | | X | |

The size of the pattern string (ACATGA) is six. In this example, taking into account the block size (B=3) and block step (S=2), no more than two consecutive identifiers can constitute a subset corresponding to a candidate region, and thus the size of an “analysis window” used for a sliding window analysis is 2. There are two subsets of location identifiers that satisfy this requirement, as shown in Table 3: {2,3} and {8,9}. These subsets correspond to two different candidate regions of the SVG. The exact region offsets can be determined by analyzing offsets of matching blocks in the pattern string: CAT (offset=1), TGA (offset=3). The region that corresponds to subset {2,3} has offset 2×(2-1)−1 =1 and the region that corresponds to subset {8,9} has offset 2×(8-1)−1=13 (offsets are 0-based).

In certain embodiments, the number of block matches within an analysis window can vary or not be consecutive. Preferably, the number of block matches within an analysis window or interval within the global ordering sufficient to constitute a candidate mapping region (referred to herein as a substantial number, predetermined number, or threshold number) will be a value in which there is a small probability that a number of k-mers or block matches are positioned close to one another simply by chance, and not because they constitute a valid match. For example, consider three k-mers of length 5 (B=5) positioned within an interval of 100 nucleotides. The number of different combinations of 15 nucleotides (i.e., 3 k-mers of length 5) is 4̂15 (approximately 1 billion). This value is on the same scale as the size of the human genome. So, finding three k-mers of length 5 within an interval of 100 base pairs may simply be a coincidence. In this case, the substantial number of block matches within an interval to constitute a candidate mapping region may be increased to yield candidate regions that are less likely to be a product of chance. Accordingly, increasing the number of block matches sufficient to constitute a candidate region increases the specificity of matches, at a loss of sensitivity.

In certain embodiments, the parameters of S, B, and the size of the analysis window for identifying a substantial number of location identifiers constituting a subset corresponding to a candidate region can vary. In particular, the invention includes insights regarding optimal configurations of parameters such as S and B. For example, when configuring parameters, a smaller block step (5) value results in more frequent “sampling” of the path, but a correspondingly larger search index. A larger block size (B) makes for more precise matches of individual blocks (e.g., a longer search index, with each hash value having a correspondingly shorter list of location identifiers associated with it), but makes it harder to match shorter reads. However, a smaller block size (B) allows for a higher likelihood of matching blocks from the pattern string to those in the index. In general, selecting smaller parameters improves efficiency, but also results in slower processing and excessive memory consumption, as the average length of the location identifier list increases.

The ratio between S and B determines the “coverage”: if S=B, blocks being indexed while processing a path do not overlap, if S=½ B then each symbol of the path will be represented in 2 blocks, if S=⅓ B symbol will be represented in 3 blocks, etc. Our experiments show that S=½ B works very well in a general situation; though, it may not be optimal for some specific applications. The choice of block size highly depends on alphabet size and memory requirements. For DNA sequencing, preferable values of B are within the interval [8, 14].

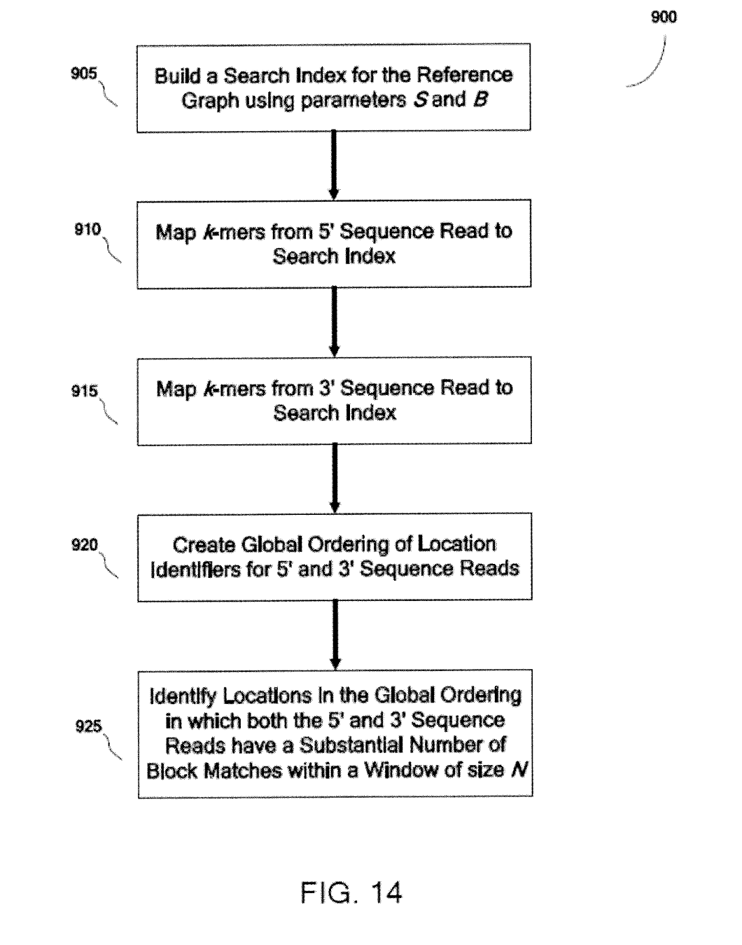

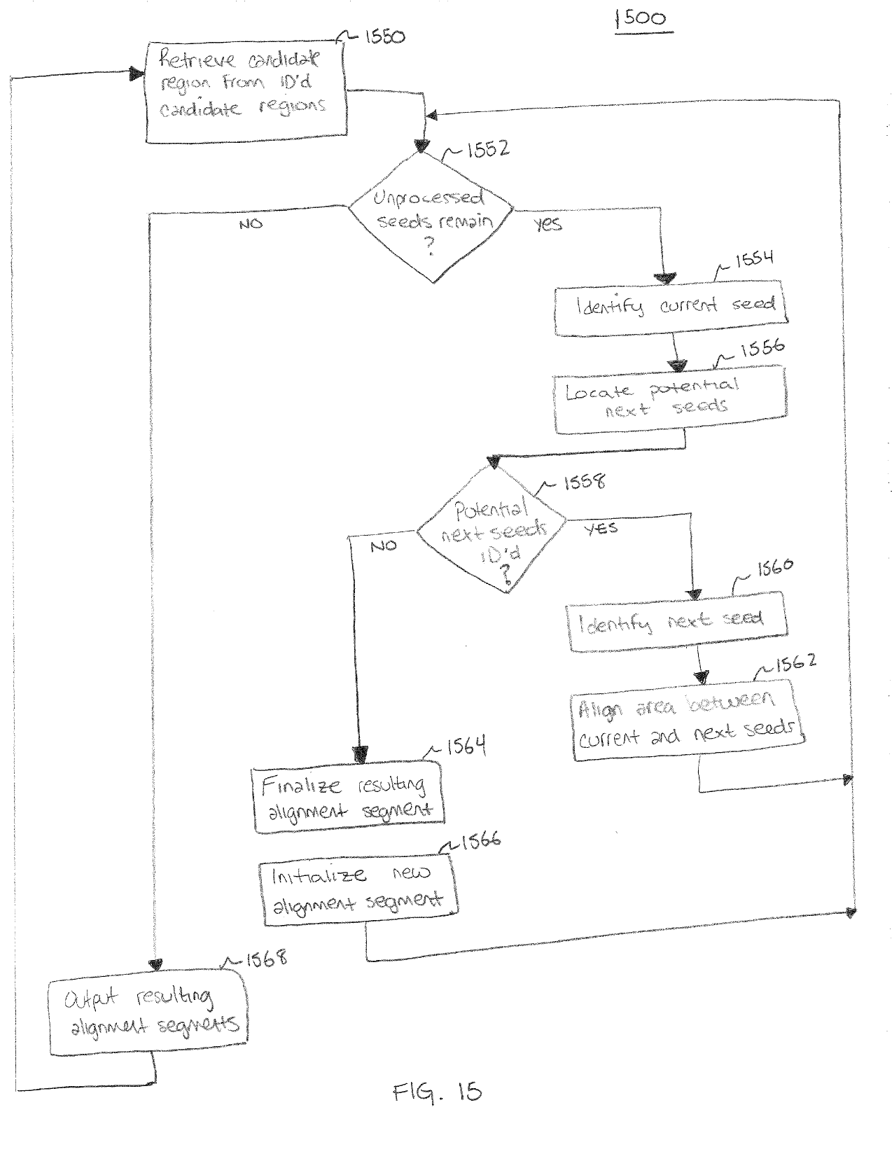

The described global search process and identification of candidate regions according to an exemplary embodiment is outlined in reference to FIG. 14. This disclosed search procedure has many advantages. First, it can efficiently locate string matches split into multiple segments. These segments can be arbitrarily permuted and/or inverted. This property makes the method extremely efficient for paired-end DNA sequencing. Second, a matching string should not necessarily be a part of a single graph path. The search procedure can find split matches with match segments located on completely different paths. These paths may overlap with different branches within a single region of the graph. As described in further detail below with reference to FIG. 15, assisted local alignment enables alignment using block matches located in different paths. Third, search does not require keeping the original graph. In many cases, match location can be determined by just analyzing the location identifiers of identified block matches. Fourth, the trade-off among processing speed, search efficiency and memory consumption can be varied in very wide ranges by properly selecting parameters S and B (parameter adjustment is discussed above). An implementation of the global search can be very efficient in terms of speed and memory consumption, or very efficient in terms of search efficiency, or deliver a certain compromise. One particular advantage of this search method over FM-index based methods is that only the hash lists for indices on the search list are operated on. Since these can easily be stored in memory, the much larger hash table can be left on disk and the search can be run with only one read operation, minimizing I/O. Finally, since only a very limited number of location identifier lists are analyzed when processing each string, a search index should not necessarily be entirely kept in operating memory. The index can be stored on an external storage device with a very large capacity (e.g., HDD/SDD drives, network etc.) so that only selected location identifier lists are loaded into the operating memory. By intelligently leveraging caching and prefetching techniques it is possible to overcome typical speed limitations of external storage (e.g., high latency of random data access). It is important to note, that this approach is fully consistent with concepts of batch processing and horizontal scaling. Thus, implementation of the proposed method can very efficient in terms of operating memory consumption. (We should also take into account the fact the search procedure does not necessarily require keeping the original data.) This makes the method applicable to extremely large collections of strings.

Use of Floating Point Projections to a Branch as Location Identifiers

Genome graphs are complex structures which describe a variety of genomic variation, including structural variations such as large insertions and deletions. These variations can be addressed by optionally employing a variation on the described search index and location identifiers in which floating-point position indicators are used. It may be found that the above-described methods can be further optimized for long indels or other structural variants. For example, it may be suspected that long insertions and deletions create “mismatched” location identifiers among different paths.

In certain embodiments, “floating point” location identifiers are used for sections of the SVG in which an alternate path has more base pairs than the corresponding section of the reference path. Floating point location identifiers provide one approach to mapping structural variants, as will be appreciated by one of skill in the art; these are discussed below.

Thus it can be seen that the invention provides methods for representing a large amount of, and large variety of genetic reference information using an SVG. In fact, a genomic reference SVG according to the invention may be used to represent all of the genetic variety existing among a large plurality of related genomes, including both small mutations such as SNPs and structural variants such as indels or transposons.

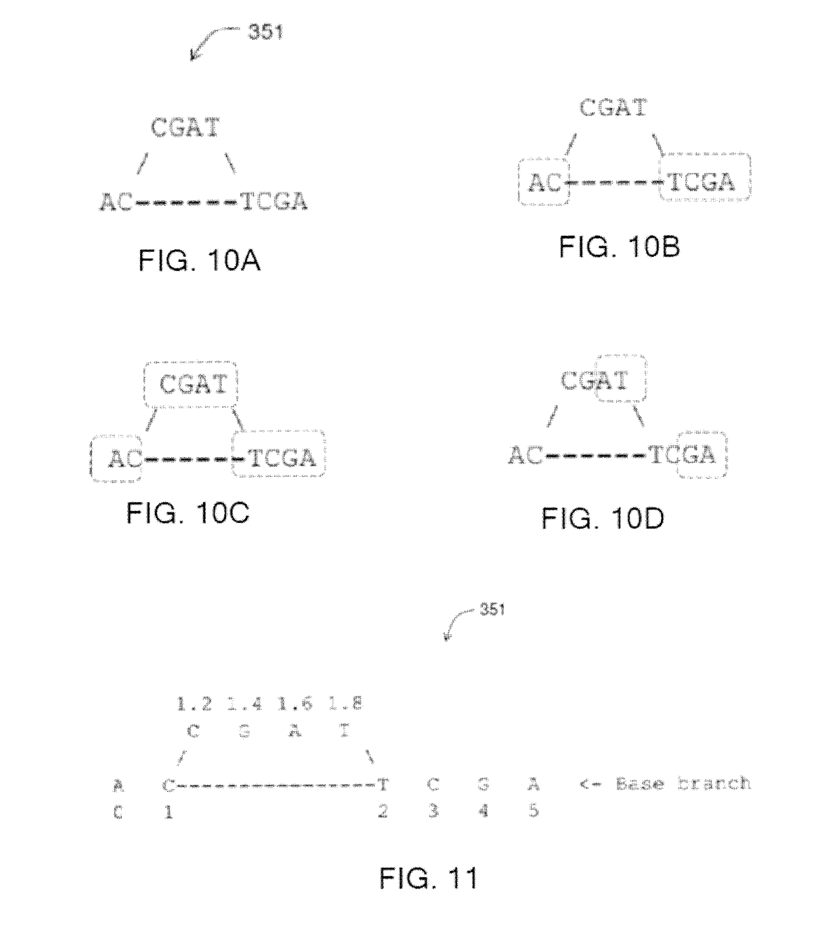

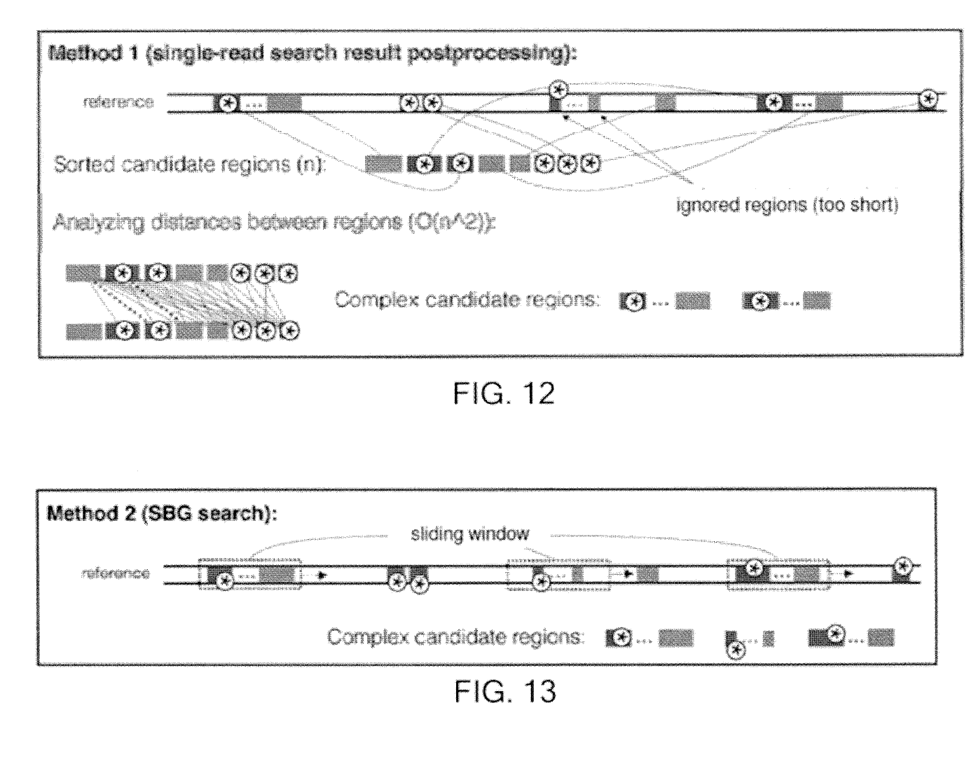

As previously noted, location identifiers based on an offset from the first position of a graph may lead to situations in which different positions in the graph may have the same location identifier. This can be avoided by using a location identifier scheme in which a divergent branch uses a modified location identifier, such as floating point projection. FIG. 10A presents an exemplary SVG 351 for consideration in connection with the following example. In this example, the object is to build a search index for the SVG 351. SVG 351 contains, among others, paths representing a data string ACCGATTCGA (SEQ ID NO: 11). For convenience, this branch will be dubbed the “base path” in the example that follows. The illustrated process includes using parameters S=2, B=2 and block number as a block location identifier.

After enumerating two different paths, two different blocks may have the same location identifier. For example, in an SVG including a large structural variant along one branch, the position of nucleotides after the insertion may end up numbered quite differently depending on which path is taken. Since location identifiers in the search index are not path-specific, a match between a block on the search list and a block in the post-insertion section of the SVG will result in “hits” at rather disparate positions.

FIG. 10B illustrates a first path through the SVG 351 corresponding to the data string ACTCGA (SEQ ID NO: 12). FIG. 10C illustrates a second path through the SVG 351, corresponding to the data string ACCGATTCGA (SEQ ID NO: 13). FIG. 10D illustrates the position of two blocks, AT and GA, and their position in the SVG 351. Those instances of blocks AT and GA have the same identifier: 3 (note that in this example, location identifiers are 0-based). Although the location identifier is the same, these blocks are actually located only slightly away (i.e., a few base pairs) from each other. However, if the alternative branch was much longer (e.g., hundreds or thousands of symbols), the distance between blocks sharing the same location identifier could be much larger. This may become a serious issue during the search, and especially when determining the offsets of the candidate regions.

As a workaround, instead of block numbers one could use floating-point projections of block start positions onto one of the branches or paths (such as the base path). FIG. 11 illustrates the use of floating-point projections of block start positions onto one of the paths, i.e., the base path, of SVG 351. The block location identifiers of the base path include AC (0), TC (2), and GA (4). The block location identifiers for the alternative path include CG (1.2) and AT (1.6). This alternative approach is more consistent with the concept of graph regions since, unlike block numbers, similar projections will always belong to the same region. (It is important to note that in this case the region corresponds to an interval on the base path and, thus, shall be specified using base path coordinates.

### Assisted Local Alignment

The above-described global searching algorithm can be used to efficiently identify candidate regions in a graph for assisted local alignment. As described above, identifying candidate regions includes locating matching blocks between a read (e.g., a query) and reference data represented in a reference graph. In example embodiments described herein, matching blocks are referred to as seeds, though both terms may be used interchangeably to refer to portions of the read that match portions of the reference data. Identified candidate region and corresponding seed information enables the assisted local alignment process to reduce the amount of data to align by only aligning relevant non-aligned data. That is, because seeds are considered to be already-aligned portions of the read, assisted local alignment aligns only those portions between the seeds in the sequence read and the reference data. In some example embodiments, assisted local alignment also or alternatively aligns non-aligned portions of the sequence read and the reference data that are adjacent to (e.g., outside, not in between) the seeds.

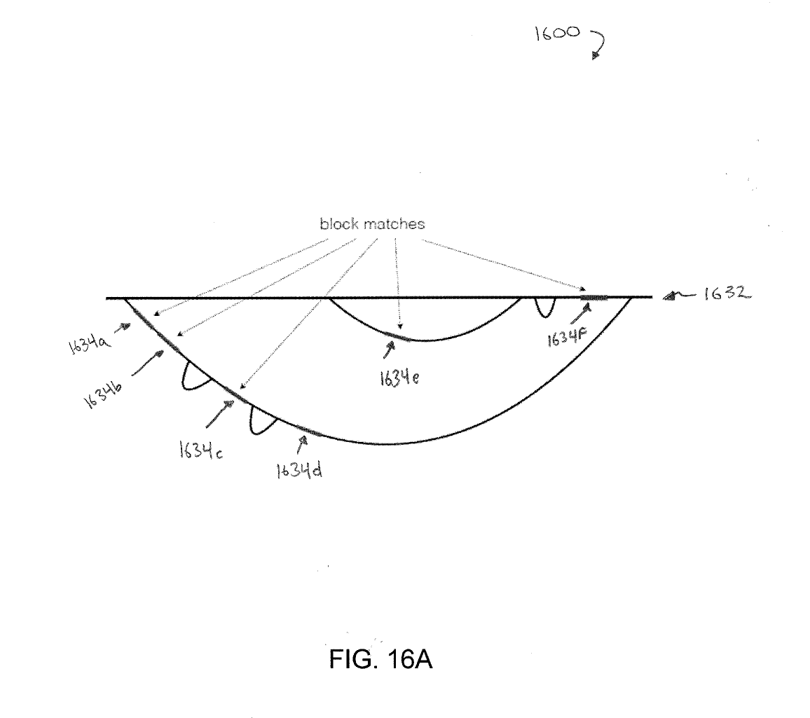

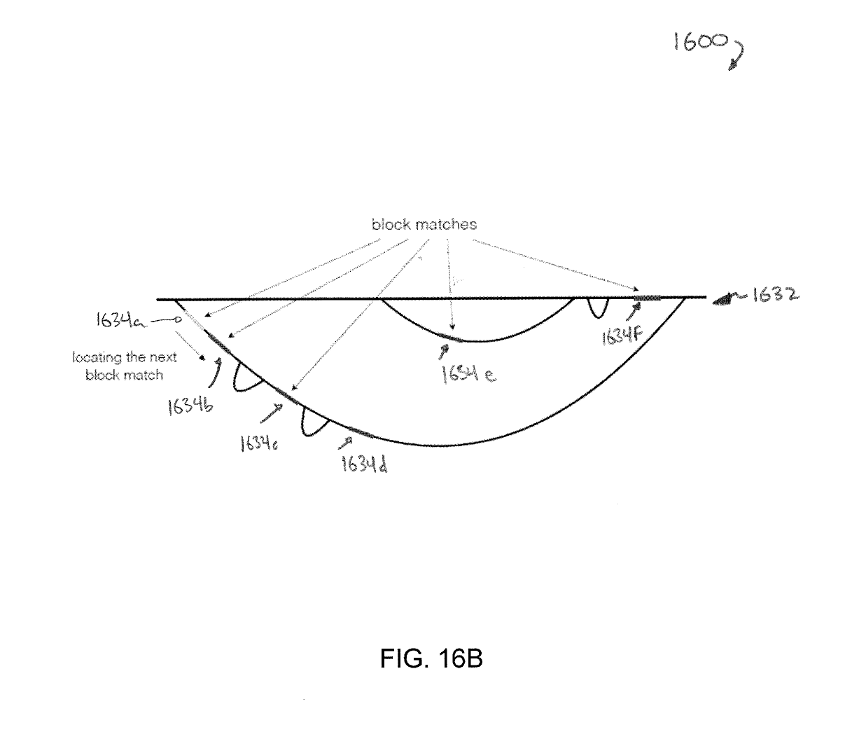

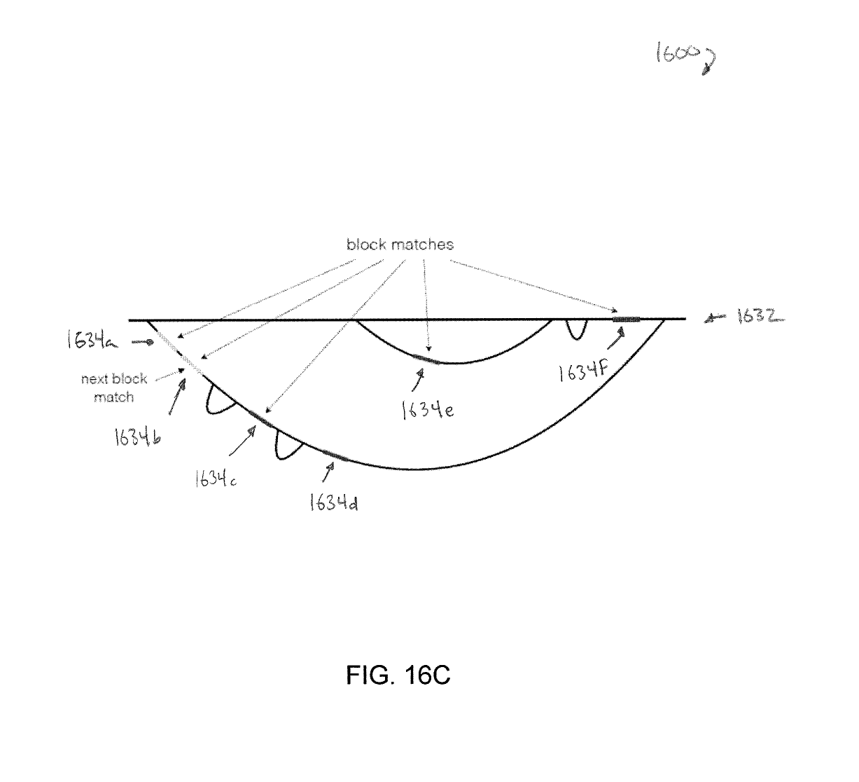

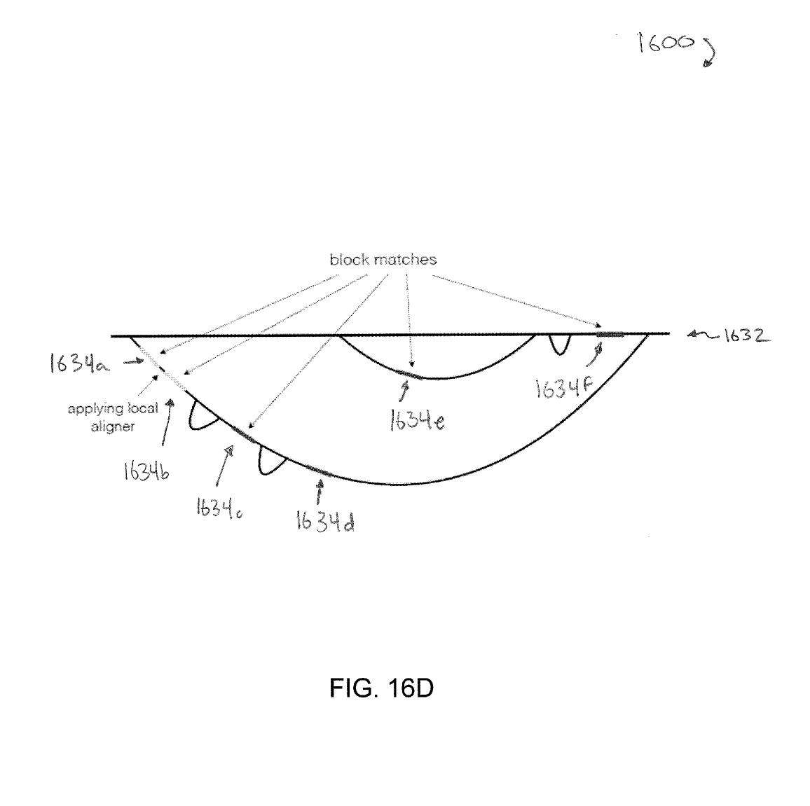

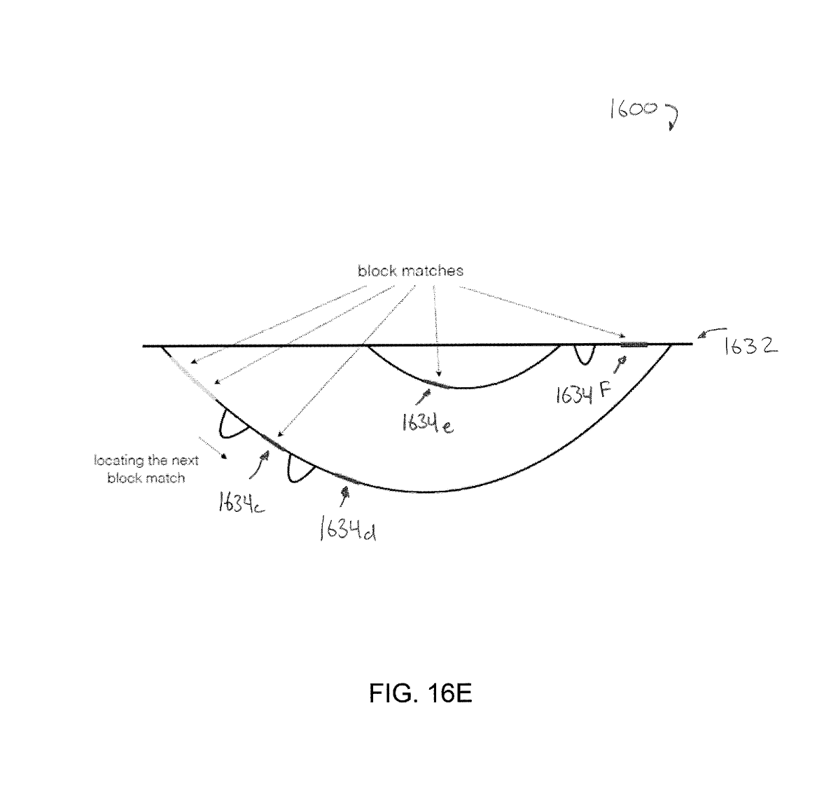

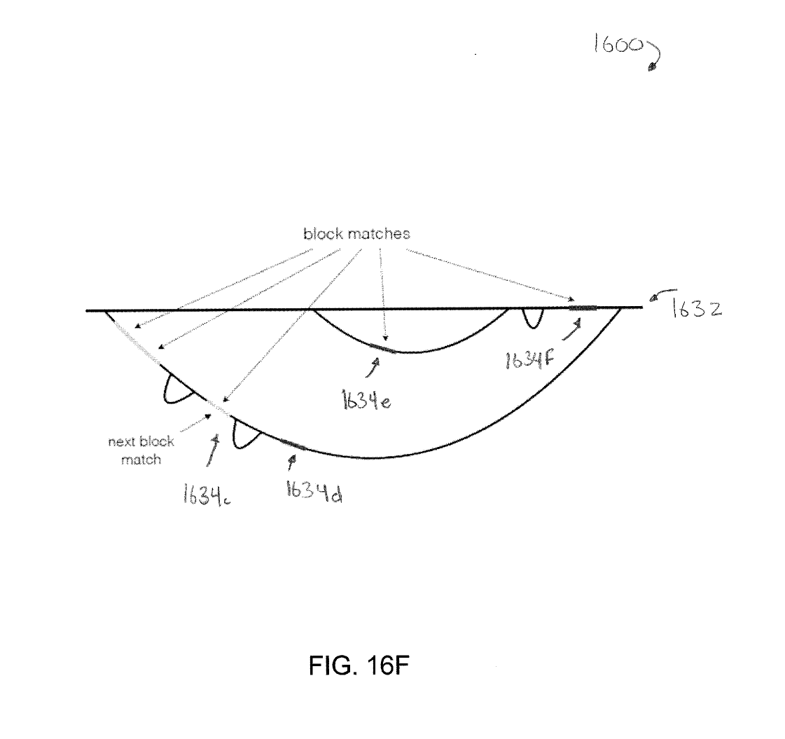

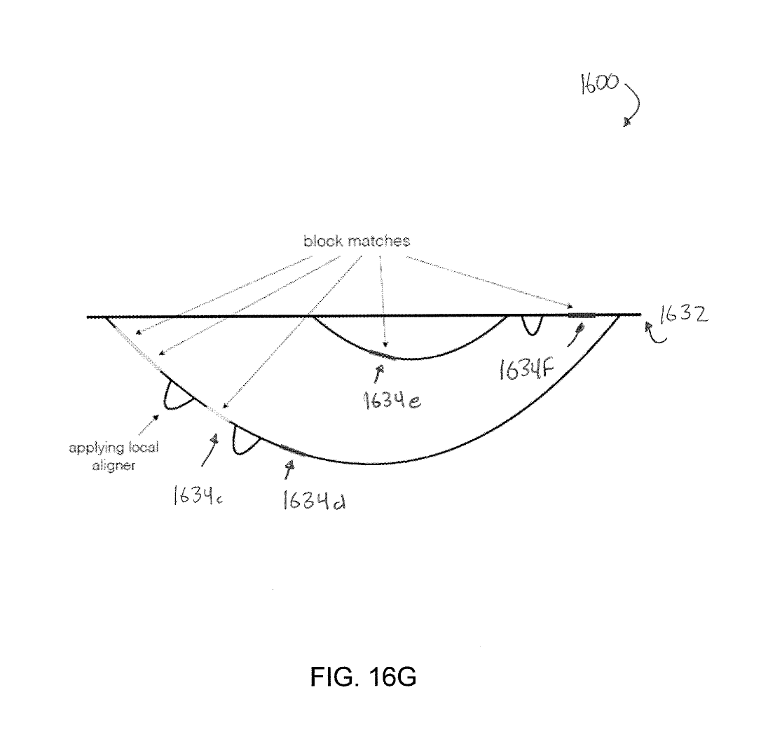

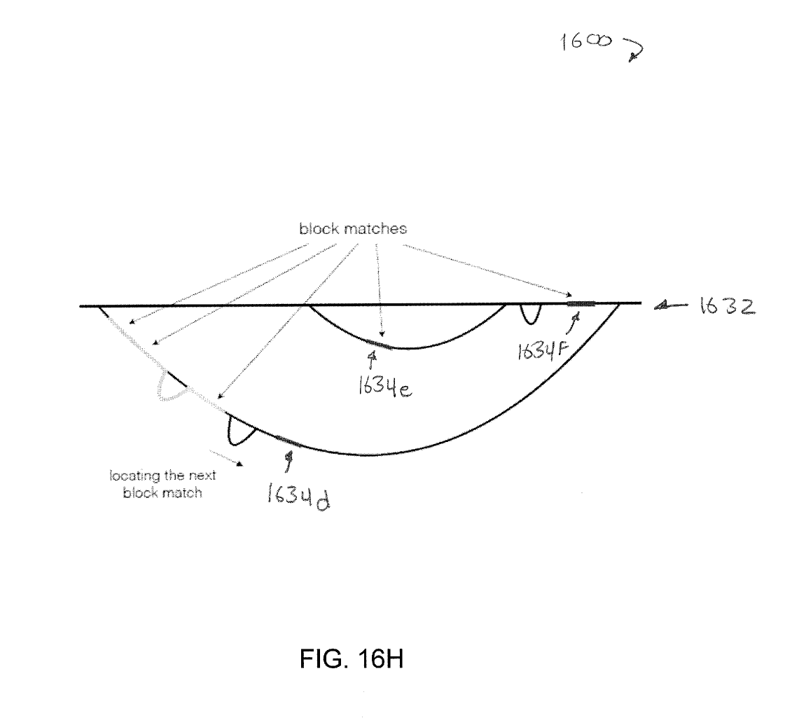

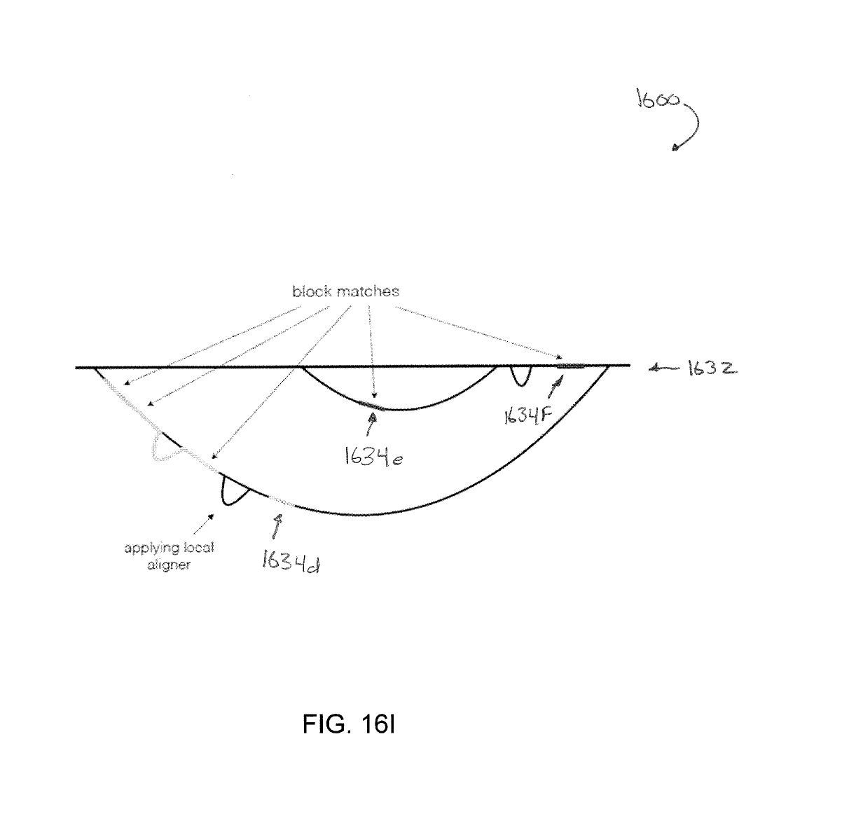

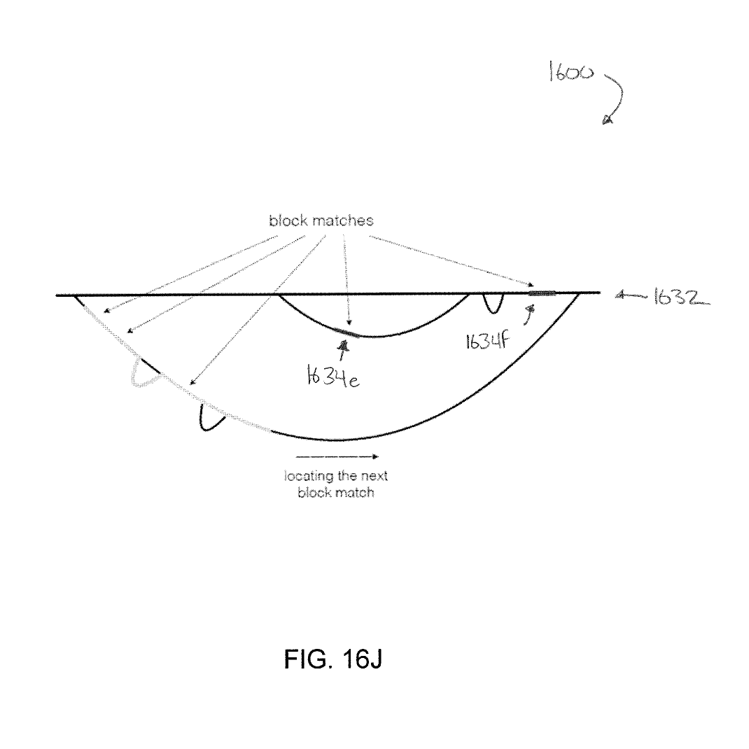

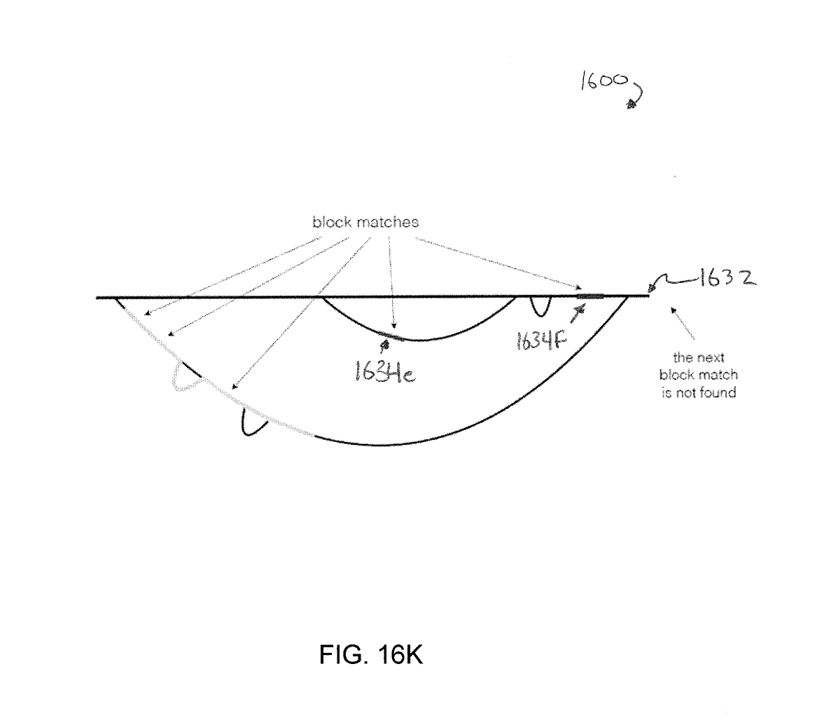

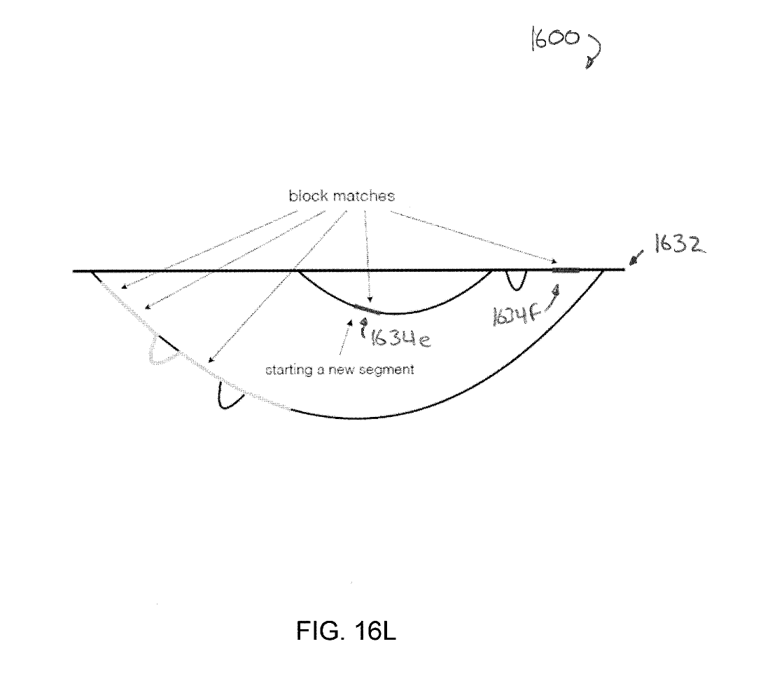

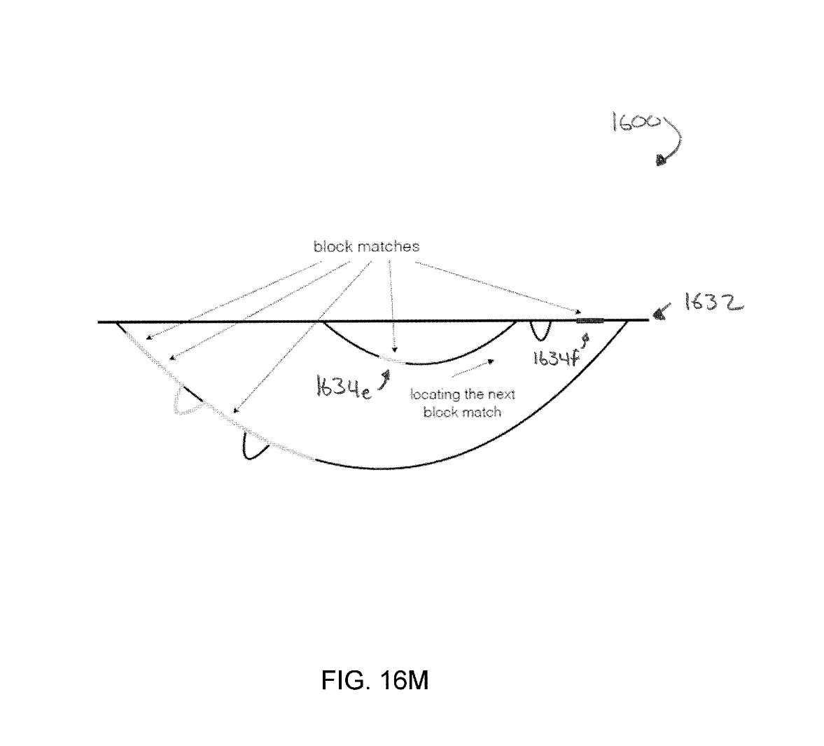

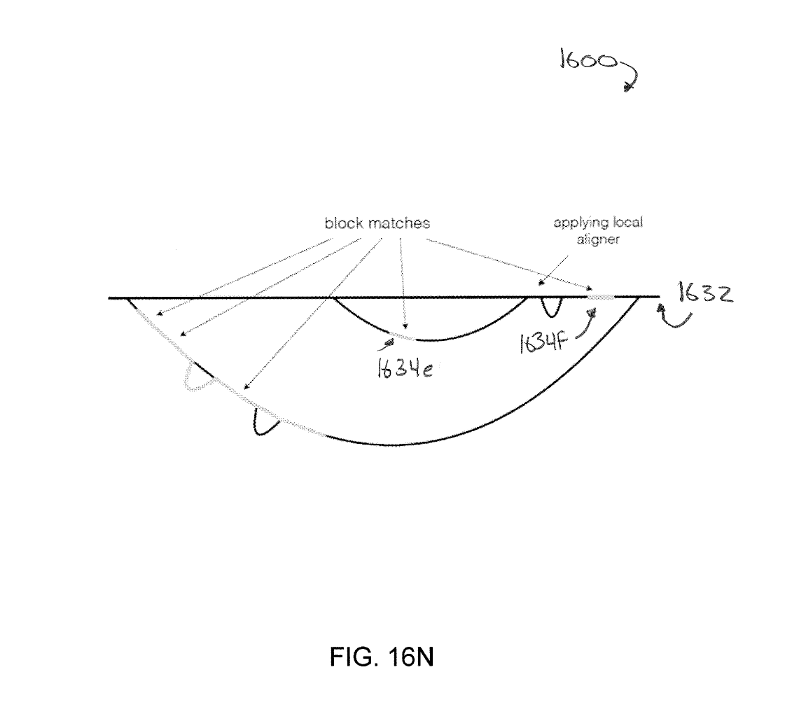

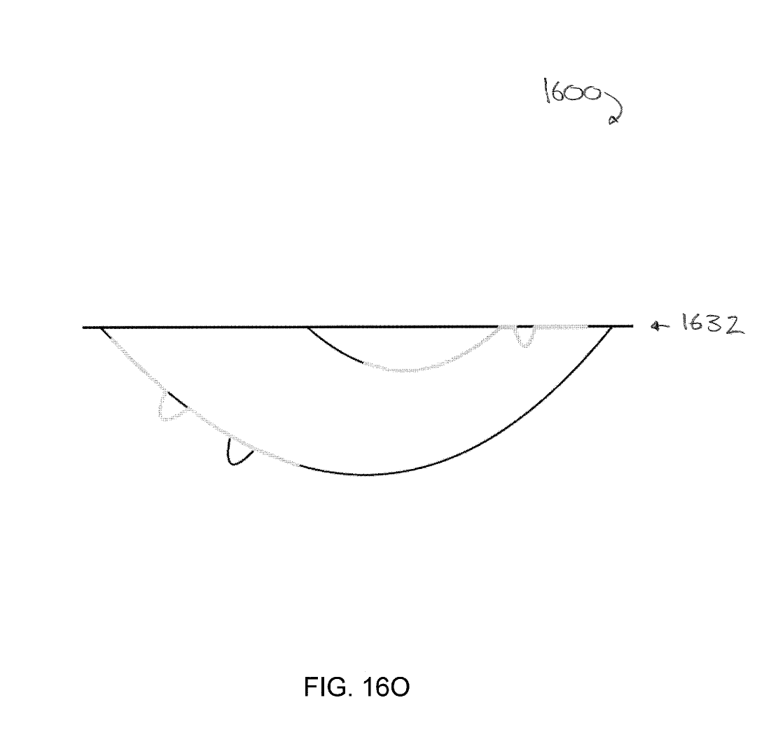

An exemplary method for performing assisted local alignment of a sequence read against candidate regions in a graph, such as an SVG, is described with reference to flowchart 1500 illustrated in FIG. 15 and the candidate region 1600 illustrated in FIGS. 16A to 16O. As described above in further detail with reference to FIG. 8 and steps SS1 to SS6, the global search algorithm identifies and/or outputs a set of candidate regions, such as candidate region 1600, located in a reference SVG representing reference sequence data. The candidate regions are areas or sections in the graph that have a substantial amount of matching data to a sequence read.

It should be understood that the candidate region 1600 shown in FIGS. 16A to 16O is a portion or subset of the SVG. Nonetheless, the candidate region is a graph representation of reference data associated with vertices and edges that make up paths within the candidate region 1600. It should also be understood that each path in the candidate region 1600 may be a portion of a path or a branch within a full reference SVG, of which a candidate region is part of. For instance, the candidate region 1600 includes multiple paths, such as base path 1632 (illustrated as a straight line in candidate region 1600) and variation paths (illustrated as curved lines branching from the reference path 1632).

The global search algorithm also provides (e.g., outputs, reports), along with each identified candidate region, and among other things, block matches and the location of the block matches in the respective candidate region. It should be understood that block matches may be referred to as seeds in the present embodiment. A seed, such as seeds 1634a to 1634f in candidate region 1600, represent a k-mer or continuous data subsequence in the candidate region that matches a k-mer or continuous data subsequence in the sequence read.

In some example embodiments, seeds in a candidate region that are determined to be misplaced or less reliable, may be discarded or ignored in order to reduce potential misalignments. Determining which seeds to discard or ignore may be done either prior to initiating or during the assisted local alignment (e.g., during the identification of current seeds and/or next seeds). For instance, in some embodiments, overlapping of adjacent seeds may be concatenated or merged into a single seed or block match. In these embodiments, those seeds having a length shorter than a desired length threshold may be ignored or discarded as having low reliability. Seeds that are determined to be ambiguously placed in the candidate region or SVG may also or alternatively be ignored or discarded. Ambiguous seeds are seeds that are found throughout the reference data. The higher the number of occurrences of a seed in a reference data (which is more likely as the seed length decreases), the more likely it is that the seed is misplaced or unreliable.

Assisted local alignment begins by selecting or retrieving, in step 1550, a candidate region for assisted local alignment, from among the set of candidate regions (and seed information) identified, for example, using the above-described global search algorithm. The candidate regions may be selected in an order based on the location, weight or other information associated with the candidate regions. In the embodiment described herein, the candidate region 1600 illustrated in FIGS. 16A to 16O is retrieved in step 1550. The retrieved candidate region 1600 is analyzed to determine if any of the seeds 1634a to 1634e is unprocessed, in step 1552. In some example embodiments, an unprocessed seed is a seed that has not been treated as a current seed in the assisted local alignment process of its corresponding candidate region. During a first iteration of the assisted local alignment process illustrated in flowchart 1500, all six of the seeds 1634a to 1634f remain to be processed (i.e., are in an unprocessed state) because they have not been used for alignment.

If it is determined in step 1552 that there are unprocessed seeds in the candidate region 1600, a current seed from among the unprocessed seeds is identified in step 1554. In some example embodiments, identifying the current seed is performed based on the location identifier of each seed, which indicates the location of the seed within the candidate region. In a first iteration of the assisted local alignment of candidate region 1600, seed 1634a which is the leftmost seed (e.g., lowest order) and is closest to the 5′ start position of the candidate region is selected and treated as the current seed. As described in further detail below, in subsequent iterations of the process illustrated in flowchart 1500, the current seed is determined based on the identity of the next seed (e.g., the next seed is treated as the current seed).

Having identified seed 1634a as the current seed, an analysis of the candidate region 1600 is performed to locate potential next seeds in step 1556. It should be understood that potential next seeds may be located on multiple branches or segments of the candidate region. That is, potential next seeds need not be on a single path on which the current seed is located. Thus, locating potential next seeds is performed by traversing all paths (e.g., branches) outgoing from the current seed 1634a. This may be done by identifying all edges outgoing from the current seed in a direction away from the start (e.g., source vertex) of the candidate region 1600, and towards the end (e.g., sink vertex) of the candidate region 1600, and traversing each of those outgoing edges until either a seed is identified or until it is determined that paths outgoing from the current seed 1634a do not lead to a next seed (e.g., because the end of the candidate region 1600 is reached). It is possible to encounter a seed on multiple paths outgoing from the current seed, such that multiple potential next seeds are identified from which to select the next seed.

As shown in FIG. 16B, there is only a single path outgoing from the current seed 1634a. Traversing that path leads to seed 1634b, as shown in FIG. 16C. The seed 1634b is added to the list of potential next seeds in step 1556. As described in further detail below with reference to FIG. 16L, multiple paths may exist between a current seed and the next seed. In such cases, if seeds are found along each of the multiple paths, those seeds are added to a list of potential next seeds. In some example embodiments in which multiple seeds are identified as potential next seeds, the next seed is selected based on one or more priority rules. Priority rules may be based on factors such as the location of each potential next seed in the candidate region or in the SVG, the length of each seed, and/or the likelihood of each seed being correctly placed in the candidate region or the SVG. In some example embodiments, a priority rule indicates that a seed with the lowest location identifier is treated as the next seed. It should be understood that these priority rules allow the assisted local alignment process to locate seeds for processing based on their priority rather than based on their order within the sequence read.

In step 1558, a determination is made as to whether any potential next seeds have been identified in step 1556. If one or more potential next seeds have indeed been identified, as determined in step 1558, a next seed is selected in step 1560. Here, because only a single path exists between the current seed 1634a and the first located potential next seed 1634b, only one seed (seed 1634b) exists as a potential next seed. Thus, the seed 1634b is selected and treated as the next seed in step 1560, at shown in FIG. 16C.

As described in further detail below with reference to FIGS. 16K and 16L, if it is determined in step 1558 that no potential next seeds have been identified in the paths outgoing from the current seed, a new alignment segment is initiated.

Once the next seed has been identified in step 1560, in step 1562, the area in the sequence read between the k-mer corresponding to the current seed 1634a and the k-mer corresponding to the next seed 1634b is aligned against the area between the current seed 1634a and the next seed 1634b in the candidate region 1600. As described below in further detail, said alignment can be performed using a variety of local aligners known by those skilled in the art, including extensions of the Smith-Waterman approach which are described, for example, in U.S. Pat. No. 9,092,402, U.S. Pat. No. 9,063,914, U.S. Pub. 2015/0112602, U.S. Pub. 2015/0057946, and U.S. Pub. 2015/0112658, the contents of which are incorporated herein by reference in their entireties. FIG. 16D illustrates the application of a local aligner to the area in the sequence read between the k-mer corresponding to the current seed 1634a and the k-mer corresponding to the next seed 1634b against the area between the current seed 1634a and the next seed 1634b. As a result, the aligned area forms a part of the alignment of a current resulting alignment segment.

In turn, once the local aligner has been applied, the assisted local alignment proceeds as follows. In step 1552, a determination is once again made as to whether unprocessed seeds remain in the candidate region 1600. Unprocessed seeds are those that have not been treated as current seeds in the assisted local alignment process. Thus, in FIG. 16D, all of the seeds except for seed 1634a are unprocessed. Accordingly, in step 1554, the current seed is identified. Other than during the first iteration of the assisted local alignment on an alignment segment of the candidate region, the then selected next seed becomes and/or is treated in step 1554 as the current seed. For instance, in FIG. 16D, seed 1634b, which is at that time selected as the next seed, becomes and is treated as the new current seed.

As shown in FIG. 16E, locating potential next seeds within the candidate region in step 1556 is performed using the seed 1634b as the current seed. As described above with reference to FIG. 16B, potential next seeds are located by traversing all paths outgoing (e.g., in a direction towards the end of the candidate region 1600) from the current seed 1634b. Although multiple paths exist between the current seed 1634b and the seed 1634c, the seed 1634c is located on a shared portion of the path, such that te search for potential next seeds performed in step 1556 stops after reaching seed 1634c. It should be understood that, in some example embodiments, seeds may belong or be located on multiple paths (or branches) of the graph.

In step 1558, a determination is made as to whether one or more potential next seeds have been located. Because only a single seed, seed 1634c, is identified as a potential next seed (relative to current seed 1634b) in step 1556, seed 1634c is selected and/or treated as the next seed in step 1560, as shown in FIG. 16F.

In turn, as shown in FIG. 16G, a local aligner is applied to (1) the area in the sequence read between the k-mer corresponding to the current seed 1634b and the k-mer corresponding to the next seed 1634c, and (2) the area between the current seed 1634b and the next seed 1634c in the candidate region 1600. As can be seen in FIG. 16G, multiple paths exist in the candidate region between the current seed 1634b and the next seed 1634c. In such cases, the local aligner may be used to align the area in the sequence read between the k-mer corresponding to the current seed 1634b and the k-mer corresponding to the next seed 1634c against both areas (e.g., along both paths) between the current seed 1634b and the next seed 1634c in the candidate region 1600. It should be understood that in some embodiments, any number of paths may exist between a current seed and a next seed, and alignments can be generated for any of said paths. The alignments resulting from applying the local aligner against all areas in paths between the current seed 1634b and the next seed 1634c may be analyzed, scored or examined to determine which to retain and discard, or to determine its plausibility. In this way, it is possible to identify an optimal alignment when multiple areas between a current seed and a next seed are aligned. The alignment with the highest score or strongest relationship to the sequence read (e.g., best fit) is retained as the alignment. In some example embodiments, analyzing, scoring or further examining the alignments can be performed at a later time. Scoring of alignments is described in further detail below with reference to FIG. 18. As shown in FIG. 16H, one of the two alignments is selected as the optimal alignment.

FIG. 16H and 16I illustrate a continuation of the alignment process. In FIGS. 16H and 16I, seed 1634c is treated as the current seed and seed 1634d is treated as the next seed. The area in the sequence read between the k-mer corresponding to the current seed 1634c and the k-mer corresponding to the next seed 1634d is aligned against the area between the current seed 1634c and the next seed 1634d in the candidate region 1600.

In turn, in step 1552, a determination is made as to whether unprocessed seeds remain in the candidate region. Because seeds 1634d, 1634e and 1634f remain to be processed as current seeds, the assisted local alignment procedure continues to step 1554, where seed 1634d, which is then the next seed, is assigned and treated as the current seed. In step 1556, and as illustrated in FIG. 16J, a search for potential next seeds relative to current seed 1634d is performed by traversing all paths outgoing from current seed 1634d toward the end of the candidate region 1600.

As shown in FIG. 16K, the end of the candidate region is reached without encountering any potential next seeds by traversing the paths outgoing from the current seed 1634d. Thus, in step 1558, it is determined that potential next seeds have not been identified. The current resulting alignment segment is finalized, in step 1564, and a new alignment segment is initialized, in step 1566, such that assisted local alignment can continue at step 1552 using seeds belonging to another segment in the candidate region 1600. The current resulting alignment segment finalized in step 1564 includes a concatenation of (1) seeds 1634a, 1634b, and 1634c, and (2) the aligned areas between the seeds 1634a, 1634b, and 1634c. That is, the resulting current alignment segment indicates an inferred relationship between the resulting alignment and the corresponding data subsequences in the sequence read. The resulting current alignment can be, then or at a later time, scored, examined or analyzed for plausibility, to determine whether it should be retained or discarded. For example, a resulting current alignment can be further analyzed and/or compared to other alignments to determine which of the alignments is optimal, or which candidate region most closely resembles the sequence read.

As shown in FIG. 16L, the new alignment segment initialized at step 1566 is processed starting with step 1552 in FIG. 15. A determination is made as to whether any seeds remain unprocessed. Because seeds 1634e and 1634f have not yet been treated as current seeds and used for alignment, assisted local alignment continues. A search for a new current seed is initiated from the start of the candidate region 1600. Traversing paths (i.e., paths not previously traversed) in the candidate region 1600 leads to two potential seeds for processing: seed 1634e and 1634f. In some example embodiments selecting one seed from among multiple seeds for processing (e.g., selecting seeds to treat as a current seed or as a next seed) is performed using priority rules, such that the seed with a higher priority is selected. For instance, priority rules may be based on one or more of the location of the seed in the candidate region (which can be determined based on, for example, the location identifier of a seed), the length of the seeds, and/or the likelihood that the seed is correctly placed in the SVG. In some example embodiments, priority rules may provide that longer seeds have higher priority than shorter seeds, that seeds with a lower location identifier (e.g., closer to the start of the SVG or candidate region) have higher priority, or that seeds with a higher likelihood of being correctly placed have higher priority.

As shown in FIG. 16L, seed 1634e is selected and treated as the current seed. This may be done based on priority rules such as those described herein (e.g., based on the location identifier of the seed 1634e versus the location identifier of the seed 1634f). In turn, seed 1634f is selected and treated as the next seed, as shown in FIG. 16M. In FIG. 16N, a local aligner is applied to (1) the area in the sequence read between the k-mer corresponding to the current seed 1634e and the k-mer corresponding to the next seed 1634f, and (2) the area between the current seed 1634e and the next seed 1634f in the candidate region 1600.

In a next iteration in which seed 1634f is treated as the current seed, it is determined in step 1558 that no potential next seeds were identified. The resulting alignment segment, which includes a concatenation of the seeds 1634e and 1634f, and the aligned area therebetween, is finalized in step 1564. In turn, it is determined at step 1552 that there are there are no remaining unprocessed seeds. In step 1568, the set of resulting alignment segments can be output, saved or further analyzed. In one example embodiment, the resulting alignment segments are illustrated as shown in FIG. 16O.

In some embodiments, assisted local alignment is used only when certain criteria of the block matches in the candidate region are met. For example, assisted local alignment is most effective when the block matches in a candidate region are ordered according to the 5′-3′ directionality of the sequence read. In these situations, the intervening regions between block matches correspond to either differences in the sequence read from the reference (i.e., variations), or seeds within the sequence read or reference that have not been indexed. Thus, aligning only the regions between reads and then concatenating the aligned regions with the block matches corresponds to the aligned position of the read. However, if the block matches are ordered in a different manner (perhaps due to larger variations or rearrangements present in the sequence read), then concatenating aligned regions between seeds may result in an inferior alignment. Accordingly, in some embodiments, the ordering of block matches is determined prior to performing local alignment. If the ordering corresponds to the 5′-3′ directionality of the sequence read, assisted local alignment may be performed to improve processing speed by leveraging the pre-aligned regions corresponding to the seeds. However, if the ordering is different, then the region may be aligned using a traditional local alignment technique, i.e. aligning the sequence read against the entire candidate region without utilizing the seed information.

In some embodiments, alignment segments are generated by concatenating seeds with the locally aligned segments between seeds. Typically the seeds represent perfect matches with the sequence read. However, the sequences associated with the locally aligned segments may include gaps, mismatches, and other variations from the reference. The entire alignment segment may further be scored, e.g., by evaluating the edit distance between the concatenated nucleotide sequence represented by the alignment segment with the corresponding reference. The highest scoring alignment segment (whether in this candidate region, or others) may then be selected as the final aligned position or location of the sequence read.

Local Alignment

Alignment generally involves placing a sequence read along part of (e.g., a candidate region) a reference graph. An alignment represents an inferred relationship between two sequences. Multiple alignments can be analyzed to identify a best-scoring match, which is deemed to be the alignment that represents an inference about what the data of the sequence read represents.

In some example embodiments, scoring an alignment of a sequence read against a portion of a candidate region can be done by setting values for the probabilities of substitutions and indels. For instance, a comparison of a base in the sequence read and a base in the candidate region can contribute to an alignment score, for example, with a +1 for a match and a −0.33 for a mismatch. An indel may deduct from an alignment score by a gap penalty of, for example, −1. A gap is a maximal substring of contiguous spaces in either x′ or y′. An alignment A can include the following three kinds of regions: (i) matched pair (e.g., x′[i]=y′[i]; (ii) mismatched pair, (e.g., x′[i]≠y′[i] and both are not spaces); or (iii) gap (e.g., either x′[i..j] or y′[i..j] is a gap). In certain embodiments, only a matched pair has a high positive score a. In some embodiments, a mismatched pair generally has a negative score b and a gap of length r also has a negative score g+rs where g, s<0. For DNA, one common scoring scheme (e.g. used by BLAST) makes score a=1, score b=−3, g=−5 and s=−2. The score of the alignment A is the sum of the scores for all matched pairs, mismatched pairs and gaps. The alignment score of x and y can be defined as the maximum score among all possible alignments of x and y.

In some embodiments, any pair has a score a defined by a 4×4 matrix B of substitution probabilities. For example, B(i,i)=1 and 0<B(i,j)i<>j<1 is one possible scoring system. For instance, where a transition is thought to be more biologically probable than a transversion, matrix B could include B(C,T)=.7 and B(A,T)=.3, or any other set of values desired or determined by methods known in the art.

Alignment according to some embodiments of the invention includes pairwise alignment. A pairwise alignment, generally, involves—for sequence Q (query) having m characters and a reference genome T (target) of n characters—finding and evaluating possible local alignments between Q and T. For any 1<i<n and 1<j<m, the largest possible alignment score of T[h..i] and Q[k..j], where h≤i and k≤j, is computed (i.e. the best alignment score of any substring of T ending at position i and any substring of Q ending at position j). This can include examining all substrings with cm characters, where c is a constant depending on a similarity model, and aligning each sub string separately with Q. Each alignment is scored, and the alignment with the preferred score is accepted as the alignment. One of skill in the art will appreciate that there are exact and approximate algorithms for sequence alignment. Exact algorithms will find the highest scoring alignment, but can be computationally expensive. Two well-known exact algorithms are Needleman-Wunsch (J Mol Biol, 48(3):443-453, 1970) and Smith-Waterman (J Mol Biol, 147(1):195-197, 1981; Adv. in Math. 20(3), 367-387, 1976). A further improvement to Smith-Waterman by Gotoh (J Mol Biol, 162(3), 705-708, 1982) reduces the calculation time from O(m²n) to O(mn) where m and n are the sequence sizes being compared and is more amendable to parallel processing. In the field of bioinformatics, it is Gotoh's modified algorithm that is often referred to as the Smith-Waterman algorithm. Smith-Waterman approaches are being used to align larger sequence sets against larger reference sequences as parallel computing resources become more widely and cheaply available. See, e.g., Amazon's cloud computing resources. All of the journal articles referenced herein are incorporated by reference in their entireties.

The Smith-Waterman (SW) algorithm aligns linear sequences by rewarding overlap between bases in the sequences, and penalizing gaps between the sequences. Smith-Waterman also differs from Needleman-Wunsch, in that SW does not require the shorter sequence to span the string of letters describing the longer sequence. That is, SW does not assume that one sequence is a read of the entirety of the other sequence. Furthermore, because SW is not obligated to find an alignment that stretches across the entire length of the strings, a local alignment can begin and end anywhere within the two sequences.

In some embodiments, pairwise alignment proceeds according to dot-matrix methods, dynamic programming methods, or word methods. Dynamic programming methods generally implement the Smith-Waterman (SW) algorithm or the Needleman-Wunsch (NW) algorithm. Alignment according to the NW algorithm generally scores aligned characters according to a similarity matrix S(a,b) (e.g., such as the aforementioned matrix B) with a linear gap penalty d. Matrix S(a,b) generally supplies substitution probabilities. The SW algorithm is similar to the NW algorithm, but any negative scoring matrix cells are set to zero. The SW and NW algorithms, and implementations thereof, are described in more detail in U.S. Pat. No. 5,701,256 and U.S. Pub. 2009/0119313, both herein incorporated by reference in their entirety.

As discussed above, it may be preferable or desirable to implement the SW alignment algorithm or a modified version of (discussed in greater detail below) when aligning sequences to a direct acyclic annotated reference genome.

The SW algorithm is easily expressed for an nxm matrix H, representing the two strings of length n and m, in terms of equation (1) below:

Hₖ₀=H₀ₗ=0(for 0≤k≤n and 0≤l≤m)

Hᵢⱼ=max{H_{i-1, j-1}+s(aᵢ, bⱼ), H_{i-1,j}−Wᵢₙ, H_{i,j-1}−W_{del},0}

(for 1≤i≤n and 1≤j≤m) (1)

In the equations above, s(aᵢ,bⱼ) represents either a match bonus (when aᵢ=bⱼ) or a mismatch penalty (when aᵢ≠bⱼ), and insertions and deletions are given the penalties Wᵢₙ and W_{del}, respectively. In most instances, the resulting matrix has many elements that are zero. This representation makes it easier to backtrace from high-to-low, right-to-left in the matrix, thus identifying the alignment.

Once the matrix has been fully populated with scores, the SW algorithm performs a backtrack to determine the alignment. Starting with the maximum value in the matrix, the algorithm will backtrack based on which of the three values (H_{j-1, j-1}, H_{i-1,j}, or H_{i,-1j}) was used to compute the final maximum value for each cell. The backtracking stops when a zero is reached. The optimal-scoring alignment may contain greater than the minimum possible number of insertions and deletions, while containing far fewer than the maximum possible number of substitutions.

When applied as SW or SW-Gotoh, the techniques use a dynamic programming algorithm to perform local sequence alignment of the two strings, S and A, of sizes m and n, respectively. This dynamic programming technique employs tables or matrices to preserve match scores and avoid re-computation for successive cells. Each element of the string can be indexed with respect to a letter of the sequence, that is, if S is the string ATCGAA, S[1]=A.

Instead of representing the optimum alignment as H_{i,j} , (above), the optimum alignment can be represented as B[j,k] in equation (2) below:

B[j, k]=max(p[j, k], i[j, k], d[j, k], 0) (for 0<j≤m, 0<k<n) (2)

The arguments of the maximum function, B[j,k], are outlined in equations (3)-(5) below, wherein MISMATCH_PEN, MATCH_BONUS, INSERTION_PEN, DELETION_PEN, and OPENING_PEN are all constants, and all negative except for MATCH_BONUS (PEN is short for PENALTY). The match argument, p[j,k], is given by equation (3), below:

p[j,k]=max(p[j−1,k−1], i[j−1,k−1], d[j−1, k−1])+MISMATCH_PEN, if S[j]≠A[k] (3)

=max(p[j−1,k−1], i[j−1,k−1], d[j−1, k−1])+MATCH_BONUS, if S[j]=A[k]

the insertion argument i[j,k], is given by equation (4), below:

i[j,k]=max(p[j−1,k]+OPENING_PEN, i[j−1,k], d[j−1,k]+ (4)

OPENING_PEN)+INSERTION_PEN

and the deletion argument d[j,k], is given by equation (5), below:

d[j,k]=max(p[j,k−1]+OPENING_PEN, i[j,k−1]+ (5)

OPENING_PEN, d[j,k−1])+DELETION_PEN

For all three arguments, the [0,0] element is set to zero to assure that the backtrack goes to completion, i.e., p[0,0]=i[0,0]=d[0,0]=0.

The scoring parameters are somewhat arbitrary, and can be adjusted to achieve the behavior of the computations. One example of the scoring parameter settings (Huang, Chapter 3: Bio-Sequence Comparison and Alignment, ser. Curr Top Comp Mol Biol. Cambridge, Mass.: The MIT Press, 2002) for DNA would be:

MATCH_BONUS: 10

MISMATCH_PEN: −20

INSERTION_PEN: −40

OPENING_PEN: −10

DELETION_PEN: −5

The relationship between the gap penalties (INSERTION_PEN, OPENING_PEN) above help limit the number of gap openings, i.e., favor grouping gaps together, by setting the gap insertion penalty higher than the gap opening cost. Of course, alternative relationships between MISMATCH_PEN, MATCH_BONUS, INSERTION_PEN, OPENING_PEN and DELETION_PEN are possible.

In some embodiments, the methods and systems of the invention incorporate multi-dimensional alignment algorithms. Multi-dimensional algorithms of the invention provide for a “look-back” type analysis of sequence information (as in Smith-Waterman), wherein the look back is conducted through a multi-dimensional space that includes multiple pathways and multiple vertices. The multi-dimensional algorithm can be used to align sequence reads against the SVG-type reference. That alignment algorithm identifies the maximum value for C_{i,j} by identifying the maximum score with respect to each sequence contained at a position on the SVG (e.g., the reference sequence construct). In fact, by looking “backwards” at the preceding positions, it is possible to identify the optimum alignment across a plurality of possible paths.

The modified Smith-Waterman alignment described here, aka the multi-dimensional alignment, provides exceptional speed when performed in a genomic SVG system that employs physical memory addressing (e.g., through the use of native pointers or index free adjacency as discussed above). The combination of multi-dimensional alignment to a reference genomic SVG with the use of spatial memory addresses (e.g., native pointers or index-free adjacency) to retrieve data from objects in the reference genomic SVG improves what the computer system is capable of, facilitating whole genomic scale analysis and read assembly to be performed using the known alleles described herein.

The algorithm of the invention is carried out on a read (a.k.a. “string”) and a directed acyclic graph (such as an SVG), discussed above. For the purpose of defining the algorithm, let S be the string being aligned, and let D be the directed acyclic graph to which S is being aligned. The elements of the string, S, are bracketed with indices beginning at 1. Thus, if S is the string ATCGAA, S[1]=A, S[4]=G, etc.

In certain embodiments, for the SVG, each letter of the sequence of a vertex will be represented as a separate element, d. A predecessor of d is defined as:

(i) If d is not the first letter of the sequence of its vertex, the letter preceding din its vertex is its (only) predecessor;

(ii) If d is the first letter of the sequence of its vertex, the last letter of the sequence of any vertex (e.g., all exons upstream in the genome) that is a parent of d's vertex is a predecessor of d.

The set of all predecessors is, in turn, represented as P[d].

In order to find the “best” alignment, the algorithm seeks the value of M[j,d], the score of the optimal alignment of the first j elements of S with the portion of the SVG preceding (and including) d. This step is similar to finding H_{i,j} in equation 1 above. Specifically, determining M[j,d] involves finding the maximum of a, i, e, and 0, as defined below:

M[j,d]=max{a, i, e, 0} (6)

where

e=max{M[j, p*]+DELETE_PEN} for p* in P[d]

i=M[j−1, d]+INSERT_PEN

a=max{M[j−1, p*]+MATCH_SCORE} for p* in P[d], if S[j]=d;

max{M[j−1,p*]+MISMATCH_PEN} for p* in P[d], if S[j]≠d

As described above, e is the highest of the alignments of the first j characters of S with the portions of the SVG up to, but not including, d, plus an additional DELETE_PEN. Accordingly, if d is not the first letter of the sequence of the vertex, then there is only one predecessor, p, and the alignment score of the first j characters of S with the SVG (up-to-and-includingp) is equivalent to M[j,p]+DELETE_PEN. In the instance where d is the first letter of the sequence of its vertex, there can be multiple possible predecessors, and because the DELETE_PEN is constant, maximizing [M[j, p*]+DELETE_PEN] is the same as choosing the predecessor with the highest alignment score with the first j characters of S.

In equation (6), i is the alignment of the first j−1 characters of the string S with the SVG up-to-and-including d, plus an INSERT_PEN, which is similar to the definition of the insertion argument in SW (see equation 1).

Additionally, a is the highest of the alignments of the first j characters of S with the portions of the SVG up to, but not including d, plus either a MATCH_SCORE (if the jth character of S is the same as the character d) or a MISMATCH_PEN (if the jth character of S is not the same as the character d). As with e, this means that if d is not the first letter of the sequence of its vertex, then there is only one predecessor, i.e., p. That means a is the alignment score of the first j−1 characters of S with the SVG (up-to-and-including p), i.e., M[j−1,p], with either a MISMATCH_PEN or MATCH_SCORE added, depending upon whether d and the jth character of S match. In the instance where d is the first letter of the sequence of its vertex, there can be multiple possible predecessors. In this case, maximizing {M[j,p*]+MISMATCH_PEN or MATCH_SCORE} is the same as choosing the predecessor with the highest alignment score with the first j−1 characters of S (i.e., the highest of the candidate M[j−1,p*] arguments) and adding either a MISMATCH_PEN or a MATCH_SCORE depending on whether d and the jth character of S match.

Again, as in the SW algorithm, the penalties, e.g., DELETE_PEN, INSERT_PEN, MATCH_SCORE and MISMATCH_PEN, can be adjusted to encourage alignment with fewer gaps, etc.

As described in the equations above, the algorithm finds the optimal (i.e., maximum) value for each read by calculating not only the insertion, deletion, and match scores for that element, but looking backward (against the direction of the SVG) to any prior vertices on the SVG to find a maximum score. Thus, the algorithm is able to traverse the different paths through the SVG, which contain the known mutations. Because the graphs are directed, the backtracks, which move against the direction of the graph, follow the preferred isoform toward the origin of the graph, and the optimal alignment score identifies the most likely alignment within a high degree of certainty.

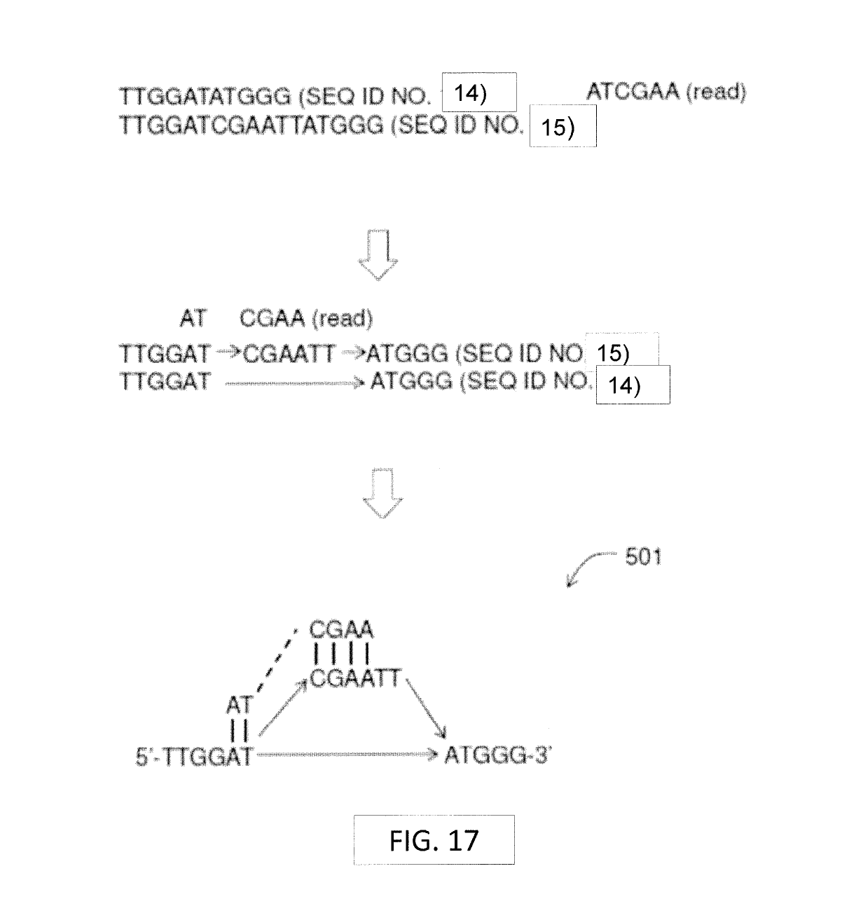

FIG. 17 describes mapping a sequence read to an SVG 501 and aids in illustrating aligning a sequence to an SVG. In the top portion of FIG. 17, a hypothetical sequence read “ATCGAA” is presented along with the following two hypothetical sequences:

(SEQ ID NO. 14)
TTGGATATGGG
(SEQ ID NO. 15)
TTGGATCGAATTATGGG

The middle portion of FIG. 17 is drawn to illustrate that SEQ ID NOS. 14 and 15 relate by a six character indel, where it is pretended that there is a prior knowledge that the hypothetical read aligns to SEQ ID NO. 15, extending into the indel. In the middle portion of FIG. 17, the depiction is linearized and simplified to aid in visualization.

The bottom portion of FIG. 17 illustrates creation of an SVG 501 to which the hypothetical sequence read is aligned. In the depicted SVG 501, SEQ ID NOS. 14 and 15 can both be read by reading from the 5′ end of SVG 501 to the 3′ end of the SVG, albeit along different paths. The sequence read is shown as aligning to the upper path as depicted.

FIG. 18 shows the matrices that represent the comparison. Like the Smith-Waterman technique, the illustrated algorithm of the invention identifies the highest score and performs a backtrack to identify the proper location of the read. In the instances where the sequence reads include variants that were not included in the SVG, the aligned sequence will be reported out with a gap, insertion, etc.

FIG. 19 gives a diagram of a method 1001 according to certain embodiments. In general, the invention provides a method for analyzing a genetic sequence. The method includes determining positions of k-mers within an SVG that represents a plurality of genomes, storing the positions of each k-mer in a table entry indexed by a hash of that k-mer, and identifying a region within one of the plurality of genomes that includes a threshold number of the k-mers by reading from the table entries indexed by hashes of substrings of a subject sequence. The subject sequence may be mapped to the region within the one of the genomes. The described methods may be performed using software created in any suitable development environment or language.

Any development environment or language known in the art may be used to implement embodiments of the invention. Exemplary languages, systems, and development environments include Perl, C++, Python, Ruby on Rails, JAVA, Groovy, Grails, Visual Basic .NET. An overview of resources useful in the invention is presented in Barnes (Ed.), Bioinformatics for Geneticists: A Bioinformatics Primer for the Analysis of Genetic Data, Wiley, Chichester, West Sussex, England (2007) and Dudley and Butte, A quick guide for developing effective bioinformatics programming skills, PLoS Comput Biol 5(12):e1000589 (2009).

In some embodiments, methods are implemented by a computer application developed in Perl (e.g., optionally using BioPerl). See Tisdall, Mastering Perl for Bioinformatics, O'Reilly & Associates, Inc., Sebastopol, Calif. 2003. In some embodiments, applications are developed using BioPerl, a collection of Perl modules that allows for object-oriented development of bioinformatics applications. BioPerl is available for download from the website of the Comprehensive Perl Archive Network (CPAN). See also Dwyer, Genomic Perl, Cambridge University Press (2003) and Zak, CGI/Perl, 1st Edition, Thomson Learning (2002).

In certain embodiments, applications are developed using Java and optionally the BioJava collection of objects, developed at EBI/Sanger in 1998 by Matthew Pocock and Thomas Down. BioJava provides an application programming interface (API) and is discussed in Holland, et al., BioJava: an open-source framework for bioinformatics, Bioinformatics 24(18):2096-2097 (2008). Programming in Java is discussed in Liang, Introduction to Java Programming, Comprehensive (8th Edition), Prentice Hall, Upper Saddle River, N.J. (2011) and in Poo, et al., Object-Oriented Programming and Java, Springer Singapore, Singapore, 322 p. (2008).

Applications can be developed using the Ruby programming language and optionally BioRuby, Ruby on Rails, or a combination thereof. Ruby or BioRuby can be implemented in Linux, Mac OS X, and Windows as well as, with JRuby, on the Java Virtual Machine, and supports object oriented development. See Metz, Practical Object-Oriented Design in Ruby: An Agile Primer, Addison-Wesley (2012) and Goto, et al., BioRuby: bioinformatics software for the Ruby programming language, Bioinformatics 26(20):2617-2619 (2010).

Systems and methods of the invention can be developed using the Groovy programming language and the web development framework Grails. Grails is an open source model-view-controller (MVC) web framework and development platform that provides domain classes that carry application data for display by the view. Grails domain classes can generate the underlying database schema. Grails provides a development platform for applications including web applications, as well as a database and an object relational mapping framework called Grails Object Relational Mapping (GORM). The GORM can map objects to relational databases and represent relationships between those objects. GORM relies on the Hibernate object-relational persistence framework to map complex domain classes to relational database tables. Grails further includes the Jetty web container and server and a web page layout framework (SiteMesh) to create web components. Groovy and Grails are discussed in Judd, et al., Beginning Groovy and Grails, Apress, Berkeley, Calif., 414 p. (2008); Brown, The Definitive Guide to Grails, Apress, Berkeley, Calif., 618 p. (2009).

Methods described herein can be performed using a system that includes hardware as well as software and optionally firmware.

Methods described herein can be performed using a system that includes hardware as well as software and optionally firmware.

FIG. 18 illustrates a system 1401 useful for performing methods described herein. Information about identified nucleotides are received at a computer from chip 1405. Sequence reads are received from sequencer 1455, either direct from the instrument or via a computer 1451 used for preliminary collection and any processing of sequence reads. Network 1415 relays data and information among the different computers. Steps of methods described herein may be performed by a server computer 1409 or by a personal computing device 1433 (e.g., a laptop, desktop, tablet, etc.) Computing device 1433 can be used to interact with server 1409 to initiate method steps or obtain results. In generally, a computer includes a processor coupled to memory and at least one input/output device.

A processor may be any suitable processor such as the microprocessor sold under the trademark XEON E7 by Intel (Santa Clara, Calif.) or the microprocessor sold under the trademark OPTERON 6200 by AMD (Sunnyvale, Calif.).

Memory generally includes a tangible, non-transitory computer-readable storage device and can include any machine-readable medium or media on or in which is stored instructions (one or more software applications), data, or both. The instructions, when executed, can implement any or all of the functionality described herein. The term “computer-readable storage device” shall be taken to include, without limit, one or more disk drives, tape drives, flash drives, solid stated drives (SSD), memory devices (such as RAM, ROM, EPROM, etc.), optical storage devices, and/or any other non-transitory and tangible storage medium or media.

Input/output devices according to the invention may include a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, an accelerometer, a microphone, a cellular radio frequency antenna, and a network interface device, which can be, for example, a network interface card (NIC), Wi-Fi card, or cellular modem.

References and citations to other documents, such as patents, patent applications, patent publications, journals, books, papers, web contents, have been made throughout this disclosure. All such documents are hereby incorporated herein by reference in their entirety for all purposes.

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method of aligning a data sequence to one or more reference sequences represented as a sequence variation graph (SVG), the method comprising the steps of:
receiving one or more alignment candidate regions and corresponding ordered seeding information for seeds in each of the one or more alignment candidate regions, each of the alignment candidate regions representing a subset of the SVG identified based on a query data sequence; and
for each of the received alignment candidate regions:
(i) determining a current seed, the current seed being a next-in-order unprocessed seed based on the ordered seeding information;
(ii) traversing data paths in the alignment candidate region that start after the current seed determined in step (i) to find potential next seeds relative to the current seed;
(iii) if at least one potential next seed is found in step (ii), selecting a next seed from among the potential next seeds, and generating alignment results by applying a local alignment procedure to align (a) query data in portions of the query data sequence located between the current seed and the next seed, and (b) reference data in portions of the alignment candidate region located between the current seed and the next seed;
(iv) if at least one potential next seed is not found in step (ii), generating a concatenated result by concatenating the alignment results and returning the concatenated result as a next alignment; and
(v) if there is at least one unprocessed seed in the alignment candidate region, returning to step (i).

2. The method of claim 1, wherein if more than one seed is found in step (ii) during the traversal of the reference graph, the next seed is selected in accordance with one or more priority rules.

3. The method of claim 2, wherein the next-in-order unprocessed seed has a highest priority based on the one or more priority rules.

4. The method of claim 2, wherein at least one of the one or more priority rules takes into account one or more of the estimated probability of a seed being correctly placed in the SVG and the length of a seed.

5. The method of claim 4, wherein seeds having a length shorter than a length threshold and/or having an ambiguous placement determined based on the estimated probability of being correctly placed in the SVG, are excluded from consideration such that they are not considered as current seeds or as potential next seeds.

6. The method of claim 1, further comprising scoring the concatenated result.

7. The method of claim 6, wherein scoring the concatenated result comprises calculating an edit distance between the concatenated result and the corresponding portions of the alignment candidate region.

8. The method of claim 1, wherein the concatenated result is further analyzed for plausibility.

9. The method of claim 1, wherein the one or more alignment candidate regions and the ordered seeding information are determined using a global search algorithm.

10. The method of claim 1, wherein the local alignment procedure is a graph local alignment.

11. The method of claim 1, wherein the query data sequence comprises nucleotide/acid sequences and the reference graph represents reference nucleotide/acid data, such that the applying of the local alignment procedure is performed on the query data sequence and the reference graph.

12. The method of claim 1, wherein the method is applied for fuzzy text data matching.

13. The method of claim 1, further comprising:
for each of the received alignment candidate regions, determining whether the ordered seeding information corresponds to the 5′-3′ direction of the data sequence.

14. A system for aligning a data sequence to one or more reference sequences represented as a sequence variation graph (SVG), the system comprising:
at least one processor operable to:
receive one or more alignment candidate regions and corresponding ordered seeding information for seeds in each of the one or more alignment candidate regions, each of the alignment candidate regions representing a subset of the SVG identified based on a query data sequence; and
for each of the received alignment candidate regions:
(i) determine a current seed, the current seed being a next-in-order unprocessed seed based on the ordered seeding information;
(ii) traverse data paths in the alignment candidate region that start after the current seed determined in (i) to find potential next seeds relative to the current seed;
(iii) if at least one potential next seed is found in (ii), select a next seed from among the potential next seeds, and generate alignment results by applying a local alignment procedure to align (a) query data in portions of the query data sequence located between the current seed and the next seed, and (b) reference data in portions of the alignment candidate region located between the current seed and the next seed;
(iv) if at least one potential next seed is not found in (ii), generate a concatenated result by concatenating the alignment results and return the concatenated result as a next alignment; and
(v) if there is at least one unprocessed seed in the alignment candidate region, return to (i).

15. The system of claim 14, wherein if more than one seed is found in (ii) during the traversal of the reference graph, the next seed is selected in accordance with one or more priority rules.

16. The system of claim 15, wherein the next-in-order unprocessed seed has a highest priority based on the one or more priority rules.

17. The system of claims 15, wherein at least one of the one or more priority rules takes into account one or more of the estimated probability of a seed being correctly placed in the SVG and the length of a seed.

18. The system of claim 17, wherein seeds having a length shorter than a length threshold and/or having an ambiguous placement determined based on the estimated probability of being correctly placed in the SVG, are excluded from consideration such that they are not considered as current seeds or as potential next seeds.

19. The system of claim 14, wherein the processor is further operable to score the concatenated result.

20. The system of claim 19, wherein scoring the concatenated result comprises calculating an edit distance between the concatenated result and the corresponding portions of the alignment candidate region.


SEQUENCE LISTING (15 sequences)

SEQ ID NO: 1 - DNA, 32 bp, Homo sapiens
cccagaacgttgcatcgtagacgagtttcagc

SEQ ID NO: 2 - DNA, 47 bp, homo sapiens
cccagaacgttgctatgcaacaagggacatcgtagacgagtttcagc

SEQ ID NO: 3 - DNA, 47 bp, homo sapiens
cccagaacgttgctatgcaggaagggacatcgtagacgagtttcagc

SEQ ID NO: 4 - DNA, 23 bp, homo sapiens
ttgctatgcaggaagggacatcg

SEQ ID NO: 5 - DNA, 12 bp, homo sapiens
cccagaacgttg

SEQ ID NO: 6 - DNA, 23 bp, homo sapiens
catcgtagacgagtttcagcatt

SEQ ID NO: 7 - DNA, 23 bp, homo sapiens
gacatgagagtccaattctgatt

SEQ ID NO: 8 - DNA, 23 bp, homo sapiens
gacatgagattccaattctgatt

SEQ ID NO: 9 - DNA, 27 bp, homo sapiens
gacatgagagtccacatgattctgatt

SEQ ID NO: 10 - DNA, 27 bp, homo sapiens
gacatgagattccacatgattctgatt

SEQ ID NO: 11 - DNA, 10 bp, homo sapiens
accgattcga

SEQ ID NO: 12 - DNA, 6 bp, homo sapiens
actcga

SEQ ID NO: 13 - DNA, 10 bp, homo sapiens
accgattcga

SEQ ID NO: 14 - DNA, 11 bp, homo sapiens
ttggatatggg

SEQ ID NO: 15 - DNA, 17 bp, homo sapiens
ttggatcgaattatggg